(19) United States
(12) Patent Application Publication
(10) Pub. No.: US 2006/0068870 A1
(43) Pub. Date: Mar. 30, 2006

(54) Electronic card table and method with host console

(75) Inventors: James T. Crawford III, Charlotte, NC (US); Gehrig Henderson White, Charlotte, NC (US); Jonathan Talmadge Lester, Gastonia, NC (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: PokerTek, Inc., Matthew, NC (US)

(21) Appl. No.: 11/173,511

(22) Filed: Jul. 1, 2005

Related U.S. Application Data
(63) Continuation-in-part of application No. 10/939,772, filed on Sep. 13, 2004.
(60) Provisional application No. 60/610,262, filed on Sep. 16, 2004.
(60) Provisional application No. 60/683,810, filed on May 23, 2005.

(51) Int. Cl. A63F 13/00

(52) U.S. Cl. 463/13; 273/309

(57) ABSTRACT

An electronic card game is provided to a plurality of players using an electronic card table. The electronic card table has a table top with a playing surface, a plurality of electronic player interaction areas located around a periphery of the table top and a central display area located in a central location of the table top. Each electronic player interaction area provides a player interface for interaction with one of the players. A game computer is coupled to the plurality of electronic player interaction areas and the central display area for administering the electronic card game using virtual cards and chips. A host console is coupled to the game computer for configuring the electronic player interaction areas and the central display area and for establishing parameters of the electronic card game.

The present application is a continuation-in-part of U.S. patent application Ser. No. 10/939,772, filed Sep. 13, 2004, and claims the benefit of U.S. Provisional Patent Application Ser. No. 60/610,262 filed on Sep. 16, 2004 and U.S. Provisional Patent Application Ser. No. 60/683,810, filed May 23, 2005, all of which are incorporated herein by reference.

### FIELD OF THE INVENTION

The present invention related generally to a system and method for providing an electronic card game.

### BACKGROUND OF THE INVENTION

Gaming is an increasingly popular form of entertainment. Games, particularly, games of change and skill in which one or more players play and place wagers on the outcome thereof may be played in a variety of ways, including at a casino or other venue or on the Internet. Of the various forms of games which are available for play, many are played with playing cards. Of these, poker is arguably the most popular.

Traditionally, poker is played at a table with several players wagering paper or coin money on a series of playing cards dealt from a deck of fifty-two cards. This deck is comprised of four suits at thirteen cards per suit. This form of poker requires a human dealer to coordinate the game, including dealing, wagering, folding, etc. . . . One of the problems with traditional poker is that it suffers from the possibility of human/dealer error. In “social” card games, especially poker, the players take turns acting as the dealer, but in licensed commercial gaming establishments, such as casinos, the dealer is typically a non-playing employee. Thus, another problem associated with traditional poker games in this context is the training and retention of dealers.

One alternative form of gaming, with particular reference to poker, has flourished on the internet. Internet gaming has become quite successful in that it provides many choices for the players. In particular, Internet gaming is fast and convenient, with registration, betting and payouts available from almost any computer with Internet access and with payments typically arranged via a credit card.

Poker or other card games may also be provided by stand-alone machines similar to slot machines.

One major drawback of internet and stand-alone type games is the lack of the human element. Many people prefer to play poker against other players, due in part to the drama associated with “live” gaming. Undoubtedly, an elevated level of competition exists when humans compete directly against one another. In gaming establishments, experienced players are trying to hone strategy and read other players' intentions through their movements and style of play to be more competitive.

The present invention is aimed at one or more of the problems set forth above.

### SUMMARY OF THE INVENTION

In a first aspect of the present invention, the system provides an electronic card game to a plurality of players. The system includes at least one electronic card table, again computer, and host console. The at least one electronic card table includes a tabletop with a playing surface and a plurality of electronic player interaction area's locator on a per three of the tabletop. Each electronic player interaction area provides a player interface for interaction with one of the players. The game computer is coupled to the plurality of electronic player interaction areas and the central display area for administering the electronic card games using virtual cards and chips. The host console is coupled to the game computer for configuring the electronic player interaction areas and the central display area and for establishing parameters of electronic card game.

In a second aspect of the present invention, a method provides an electronic card game to a plurality of players on an electronic card table using a host console and a server computer. The electronic card table includes a tabletop with a playing surface, a plurality of electronic player interaction areas located around the periphery of the tabletop, and a central display area located in a central location of the table top. Each electronic player interaction area provides a player interface for interaction with one of the players. The method includes the steps of configuring the electronic player interaction areas and the center display area and establishing parameters of electronic card game using the host console and administering an electronic card game, by the game computer using virtual cards and chips.

In a third aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for sole for allowing the operator to turn the at least one electronic card table on and off.

In a fourth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for allowing the operator to select one of the plurality of card games to be played at the at least one electronic card table.

In a fifth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for establishing parameters of the electronic card game, wherein the parameters are time related and/or include wager limits and/or indicate the card game as a timed game or a non-timed game.

In a sixth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer for monitoring players who log onto the electronic player interact areas and a user interface implemented on the host console for use by an operator of the host console. The user interface for signaling the operator of the host console if a designated player logs on.

In a seventh aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer for establishing a rate of play of hands at the at least one electronic card table and a user interface implemented on the host console for use by an operator of the host console. The user interface for displaying the rate of play of hands.

In a eighth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for allowing the operator to adjust a stack of virtual chips associated with one of the players.

In a ninth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for establishing or modifying one or more game profiles, each game profile including parameters for a card game which may be played on the electronic card table.

In a tenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for establishing parameters of the electronic card game, the parameters including game type and/or play timing and/or minimum number of players.

In an eleventh aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for allowing the operator to start and/or stop and/or hibernate play of the electronic card game at the electronic card table.

In a twelfth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for the user interface for allowing the operator to monitor play of the electronic card game at the electronic card table.

In a thirteenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for allowing the operator to open and close the electronic card table and/or start ring or tournament games and/or start or restart or turn off or reboot the electronic player interaction areas or other component.

In a fourteenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for allowing the operator to select a wagering structure for the electronic card game.

In a fifteenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for allowing the operator to record information regarding a player.

In a sixteenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for allowing the operator to replay a hand of the electronic card game.

In a seventeenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer for receiving an alert initiated by one of the players and a user interface implemented on the host console for use by an operator of the host console. The user interface for signaling the operator in response to having received the alert.

In a eighteenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for displaying diagnostic and/or option information for the electronic card table and/or the electronic player interaction areas and/or the game computer.

In a nineteenth aspect of the present invention, a device, for use with a system for providing an electronic card game to a plurality of players, is provided. The system includes at least one electronic card table and a game computer. The electronic card table has a table top with a playing surface and a plurality of electronic player interaction areas located around a periphery of the table top. Each electronic player interaction area provides a player interface for interaction with one of the players. The game computer is coupled to the plurality of electronic player interaction areas for administering the electronic card game using virtual cards and chips. The device includes a host console coupled to the game computer and a user interface implemented on the host console for use by an operator of the host console. The user interface for displaying a graphical representation of the electronic card table.

In a twentieth aspect of the present invention, a system for providing an electronic card game to a plurality of players is provided. The system includes at least one electronic card table having a table top with a playing surface and a plurality of electronic player interaction areas located around a periphery of the table top. Each electronic player interaction area includes a player interface for interaction with one of the players. A game computer, coupled to the plurality of electronic player interaction areas, administers the electronic card game using virtual cards and chips. A host console is coupled to the game computer. The game computer, in the event of a fault of on one of the player's the electronic player interaction area, is able to transfer the one player's hand from the respective electronic player interaction area to the host console and allows the one player to finish playing the hand on the host console.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a diagrammatic illustration of a system for providing an electronic poker game on one or more electronic poker tables, according to an embodiment of the present invention;

FIG. 2 is a simplified diagram of a table top of the electronic poker tables of FIG. 1, according to an embodiment of the present invention;

FIG. 3 is a simplified diagram of a table top of the electronic poker tables of FIG. 1, according to another embodiment of the present invention;

FIG. 4 is a block diagram of the system of FIG. 1, according to an embodiment of the present invention;

FIG. 5 is a second block diagram of the system of FIG. 1, including the element of an electronic poker table, according to an embodiment of the present invention;

FIG. 6 is a diagrammatic illustration of an electronic poker table, according to an embodiment of the present invention;

FIG. 7 is a top view of the electronic poker table of FIG. 6;

FIG. 8 is a diagrammatic illustration of a module of the electronic pokertable of FIG. 6, according to an embodiment of the present invention;

FIG. 9 is a representation of a first screen shot displayed on an electronic player interaction area of the system of FIG. 1, according to an embodiment of the present invention;

FIG. 10 is a representation of a second screen shot displayed on an electronic player interaction area of the system of FIG. 1, according to an embodiment of the present invention;

FIG. 11 is a representation of an electronic player interaction area of the system of FIG. 1 embodied in a hand-held device;

FIG. 12 is a representation of a front side and a back side of an electronic playing card;

FIG. 13A is a block diagram of software components of the system of the present invention;

FIG. 13B is a simplified block diagram of a system for providing an electronic poker game, according to an embodiment of the present invention;

FIG. 14 is a block diagram of a system for providing an electronic poker game with a host console, according to an embodiment of the present invention;

FIG. 15 is a flow diagram of a method of providing an electronic poker game, according to an embodiment of the present invention; and,

FIG. 16 is a first exemplary screen shot from the host console of FIG. 14;

FIG. 17 is a second exemplary screen shot from the host console of FIG. 14;

FIG. 18 is a third exemplary screen shot from the host console of FIG. 14;

FIG. 19 is a fourth exemplary screen shot from the host console of FIG. 14;

FIG. 20 is a fifth exemplary screen shot from the host console of FIG. 14;

FIG. 21 is a sixth exemplary screen shot from the host console of FIG. 14;

FIG. 22 is a first exemplary screen shot from the host console of FIG. 14;

FIG. 23 is a seventh exemplary screen shot from the host console of FIG. 14;

FIG. 24 is an eighth exemplary screen shot from the host console of FIG. 14;

FIG. 25 is a ninth exemplary screen shot from the host console of FIG. 14;

FIG. 26 is a tenth exemplary screen shot from the host console of FIG. 14;

FIG. 27 is a eleventh exemplary screen shot from the host console of FIG. 14;

FIG. 28 is a twelfth exemplary screen shot from the host console of FIG. 14;

FIG. 29 is a thirteenth exemplary screen shot from the host console of FIG. 14;

FIG. 30 is a fourteenth exemplary screen shot from the host console of FIG. 14;

FIG. 31 is a fifteenth exemplary screen shot from the host console of FIG. 14;

FIG. 32 is a thirteenth exemplary screen shot from the host console of FIG. 14;

FIG. 33 is a sixteenth exemplary screen shot from the host console of FIG. 14; and,

FIG. 34 is a seventeenth exemplary screen shot from the host console of FIG. 14.

### DETAILED DESCRIPTION OF INVENTION

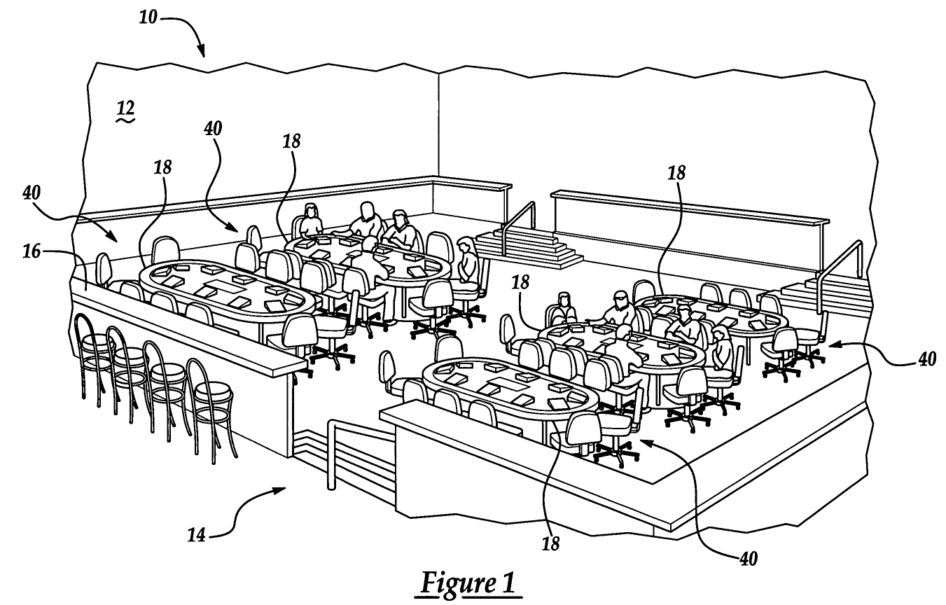

With reference to the drawings and in operation, the present invention relates generally to a system 10 and method for providing, and being related to, an electronic card game, such as poker. With specific reference to FIG. 1, the system 10 is designed to be situated in a gaming environment, such as a casino 12. Typically, such gaming environments 12 are a specialized or designated area within the casino 12, such as a poker room or poker area 14, which has been cordoned off by, for example, a railing 16. While the above refers to one possible implementation or location in which the system 10 may be used, the present invention is not limited to any such location or implementation.

In the illustrated embodiment, the system 10 utilizes electronic chips and electronic playing cards to provide an automated card game for play by one or more players. In one aspect of the present invention, a human dealer is not required. The system 10 may handle all dealer functions.

For the purposes of illustration, the system will be described as applied to an electronic poker game. However, the present invention is not limited to any particular card game.

The system 10 may be used to play any variation or version of poker. However, for the purposes of discussion, the system 10 will be described as adapted for use in implement the version of poker known as, Texas Hold'em.

In one aspect of the present invention, the system 10 may handle assigning players to a seat, providing electronic chips, accepting wagers, and assigning a pot to the winning player. The system 10 electronically shuffles a set of electronic playing cards and deals the electronic playing cards to the player and any common cards to the table 18. The system 10 may also handle wagering, folding, calling by the players and may restrict such, based on whose turn it is.

In another aspect of the present invention, the poker tables 18 in the system 10 are networked and connected to one or more servers (see below). The server may be used to implement and facilitate, player tracking, ticket in ticket out (cashless) wagering, assigning player's to a seat at a particular table, tournament play, table set-up (including turning the tables on and off and modifying table parameters), and progressive jackpots.

As shown in the illustrated embodiment, the system 10 includes a plurality of electronic poker tables 18. In the embodiment shown in FIG. 1, the system 10 includes ten electronic poker tables 18A-18J, although the present invention is not limited to a specific number of electronic poker tables.

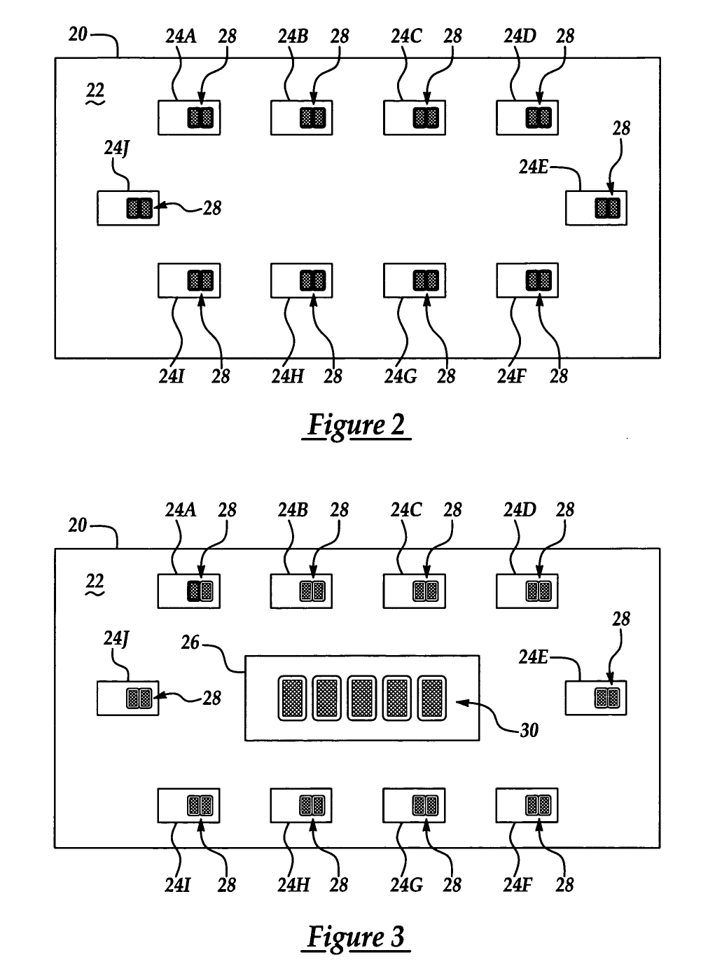

A simple representative layout of a table top 20 of the poker tables 18, according to first and second embodiments of the present invention are shown in FIGS. 2 and 3, respectively.

In the top view of the table top 20 shown in FIG. 2, the table top 20 includes a playing surface 22 and a plurality of electronic player interaction areas 24. In the illustrated embodiment, the poker tables 18 are able to seat a maximum often players at a time, and thus, includes ten electronic player interaction areas 24A-24J.

In the top view of the table top 20 shown in FIG. 3 (in which like elements are labeled with the same reference numbers), the table top 20 includes a playing surface 22 and a plurality of electronic player interaction areas (EPIA) 24. In the illustrated embodiment, the poker tables 18 are able to seat a maximum often players at a time, and thus, includes ten electronic player interaction areas 24A-24J. The table top 10 also includes a central or common display area (CDA) 26.

In one embodiment, the individual electronic player interaction areas 24A-24J are used to convey game information directly to a player assigned to a specific player interaction area 24A-24J and to implement a player user interface (see below) to effectuate interaction or input from the player. The central or common display area 26 is used to display information to all of the players.

For example in one embodiment, the system 10 is used to play the version of poker known as Texas Hold'em. In Texas Hold'em, each player is dealt a number of cards, e.g., two cards, face down. These are known as a player's “hole” cards 28. A number of cards, e.g., three or five, are dealt face-up and displayed in the common display area 26. These are known as the common cards 30. A player's hand, thus, consists of the player's hole cards 28 and the common cards 30. Whichever player's hand makes the highest poker hand is the winner of that round or hand of poker.

In one aspect of the present invention, the hole cards 28 are displayed face-down on the respective electronic player interaction area 24 and the common cards are displayed in the central display area 26. The hole cards 28 are displayed at a first predetermined ratio and the common cards 30 are displayed at a second predetermined ratio. The first and second predetermined ratios may be expressed as a ratio of a standard size playing card or a predetermined default size. In one embodiment, the first and second ratios are the same. In another embodiment, the first and second ratios are different. For example, the first and second ratios may be defined such that the common cards 30 are displayed larger than the hole cards 28.

With reference to FIGS. 6, 7, and 8 in one embodiment, the electronic player interaction areas 24 are implemented using separate display devices, such as touchscreen displays 32. Each display 32 may be housed in a removable module 34.

The module 34 may incorporate a fully-functional computer. The computer includes a processor capable of running an operating system, such as Windows XP or Windows CE, both available from Microsoft Corporation of Redmond, Wash. In one embodiment, the module 34 includes a card reader 36 for reading a player ID card (not shown).

In the illustrated embodiment, the modules 34 are mounted into the table top 20, such that the touchscreen display 32 is parallel to the table top 20. However, the touchscreen display 32 may be mounted at an angle with respect to the table top 20. Alternatively, the modules 34 may be adjustable to provide a adjustable viewing angle of the touchscreen display 32.

In one embodiment, the central display area 26 is implemented in a separate display 38, such as a LCD or plasma monitor or similar device.

The remainder of the table top may be covered in a material such as felt, or more specifically, green, blue, or red felt. Logos, game information, or other information may be printed on the material.

In an alternative embodiment, the electronic player interaction areas 24 and the central display area 26 may be implemented in a single display which covers a large portion of the table top. The electronic player interaction areas 24 and the central display area 26 may be set apart from the rest of the table top 20 by virtual borders. The areas of the display around the electronic player interaction areas 24 and the central display area 26 may be used to simulate the table top of a standard poker table, e.g., an image of material, such as green felt, may be displayed. Furthermore, logos, game information, other information, advertisements, announcements, pictures, videos, or other information may be displayed, rotated, cycled, or displayed for a limited period of time on the table top 20.

As discussed below, the system 10 and poker tables 18, although electronic, are designed to convey and retain the overall sense and ambience of a standard poker room with non-electrical poker tables. Each electronic poker table 18 is surrounded by a number of poker chairs 40. The number of poker chairs 40 being equal to the number of electronic player interaction areas 24 on the electronic poker table 18.

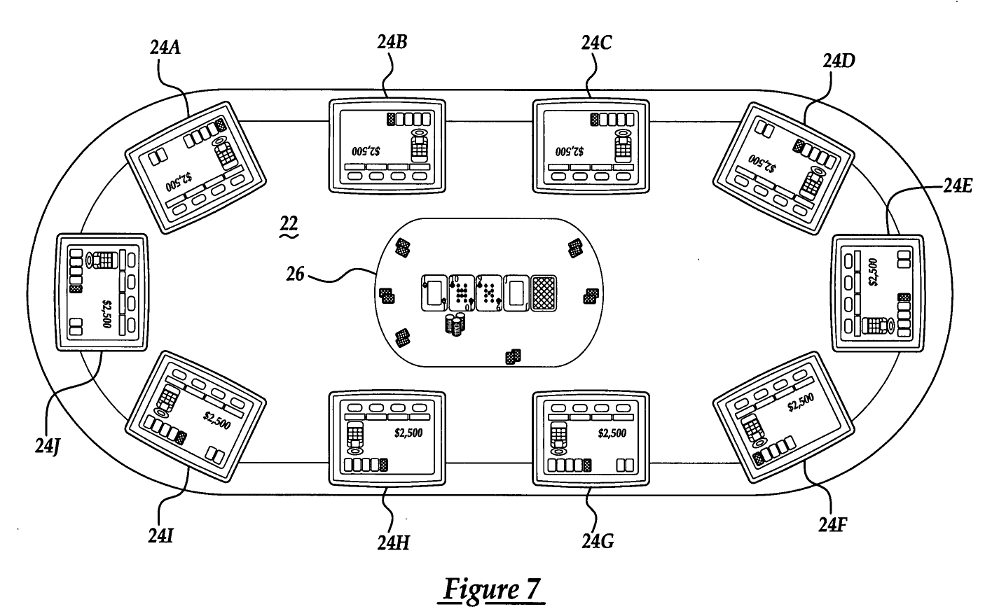

With particular reference to FIGS. 6 and 7, in the illustrated embodiment the poker tables 18 have an oval shape and may seat a maximum number of players. For example, the poker tables 18 may be sized to seat a maximum of 2-10 players, although the present invention is not limited to any particular sized poker table. As stated above the table top is covered, in between the electronic player interface area, and the central or common display area if provided, by material, such as green felt, or simulation thereof. The poker table includes two bases 42 to which one or more legs 44 are connected. The legs 44 support the table top. A rail or bumper 46 encircles the outer circumference of the table top 20.

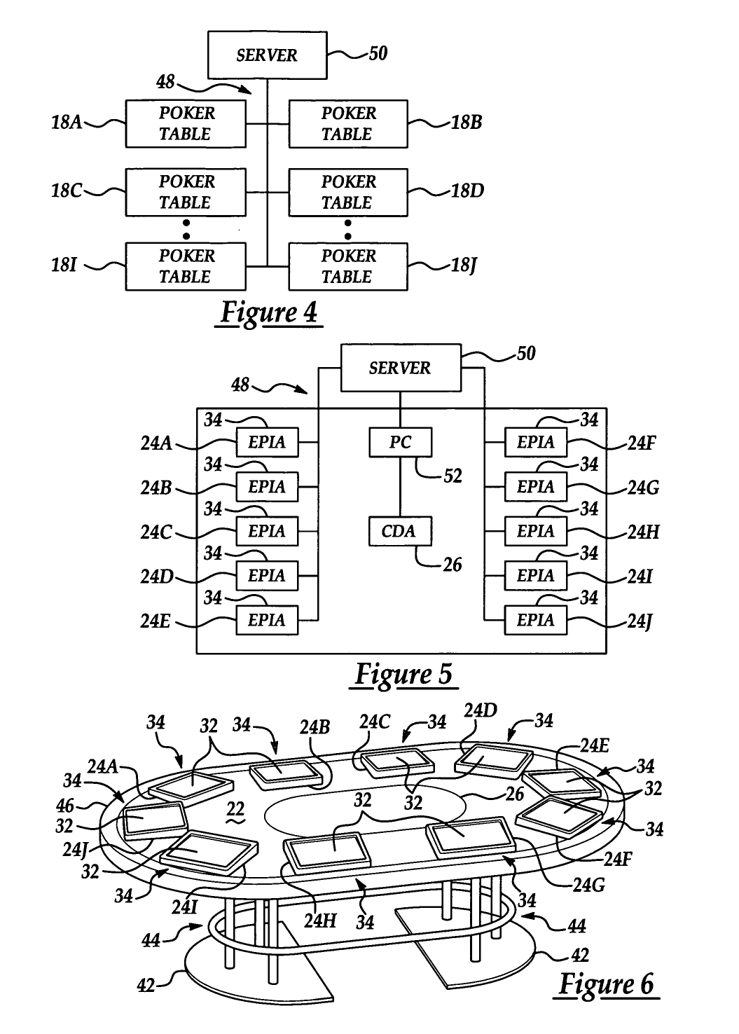

With specific reference to FIGS. 4 and 5, as discussed above the system 10 may include one or more electronic poker tables 18. In one aspect of the present invention, the poker tables 18 are networked together using, e.g., an Ethernet network 48. One or more server 50 may be used to provide functionality for the system 10. For example, the server 50 may be used to implement various functions, including, but not limited to:
data and player tracking,
cashless wagering,
defining and modifying table parameters, including, turning the tables 18 on and off, setting the poker game being played at the table 18, setting wager parameters, etc. . . . ,
defining and managing jackpots, including the a house percentage, i.e., the rake,
defining and managing progressive jackpots,
establishing and managing a queue for players and assigning players to seats and/or specific tables from the queue, and
establishing and managing tournament play, including assigning player seats, collapsing tables, etc. . . .

With particular reference to FIG. 5, in one embodiment each table 18 includes ten electronic player interface areas 24 which are implemented in a computer based module 34. Each module 34 operates or runs on an operating system, such as Microsoft Windows XP or Windows CE. Each module 34 is connected to the server 50 through the network 48. As shown, another computer 52, such as a personal computer running on Windows XP, may also be connected to the server 50 through the network 48. The primary function of the PC 52 may be to control and drive the central display area 28.

In one embodiment, the server 50 runs the poker games on each of the tables 18. The primary function of the modules 34 is to run the electronic player interface areas 34, to display and run a user interface.

In another embodiment, the poker game or portions of the poker game may be executed or run by the modules 34 and/or the computer 52.

In another aspect of the present invention, the system 10 will implement a player-account based cash in/cash out system. The system 10 will create a user account for each player. Once an account is established for the player, the player is issued a Player Card having an associated personal identification number or PIN. Once the player has been issued a Player Card, their account may be funded. The Player Card is used to identify the player at the tables 18. The player may fund their account by bringing cash to a cage, where the cash is accepted and credited to the player's account. Printed receipts are given to the player and maintained by the casino 12. To bring electronic chips to the table 18, the player sits down at a seat, swipes their Player Card and enters their PIN. The system 10 informs the player of their account balance and allows them to convert all or a portion of the account balance to electronic chips to bring to the game.

From a software perspective, the system 10 may be implemented using six program groups: a table server, a game engine, a table client, a player client, a table manager, and a cage manager. The table server implements the network communication, control and authentication as well as inter-table functions (seat reservations, multi-table tournaments). The game engine is responsible for all game functions, e.g., electronic playing card deck generation, dealing, betting, determining winners and awarding pots. The table client is the graphical control for the central data area 26. The player client implements the user interface for the electronic player interface areas 24 and the logic for capturing player input and communication the player input to the table client server. The table manager contains the user interface for setting user, network, and game parameters, for starting, pausing, and stopping games, and for monitoring game activity and responding to system or user generated alerts. The cage manager provides the ability to create and fund player accounts and to create the Player Cards.

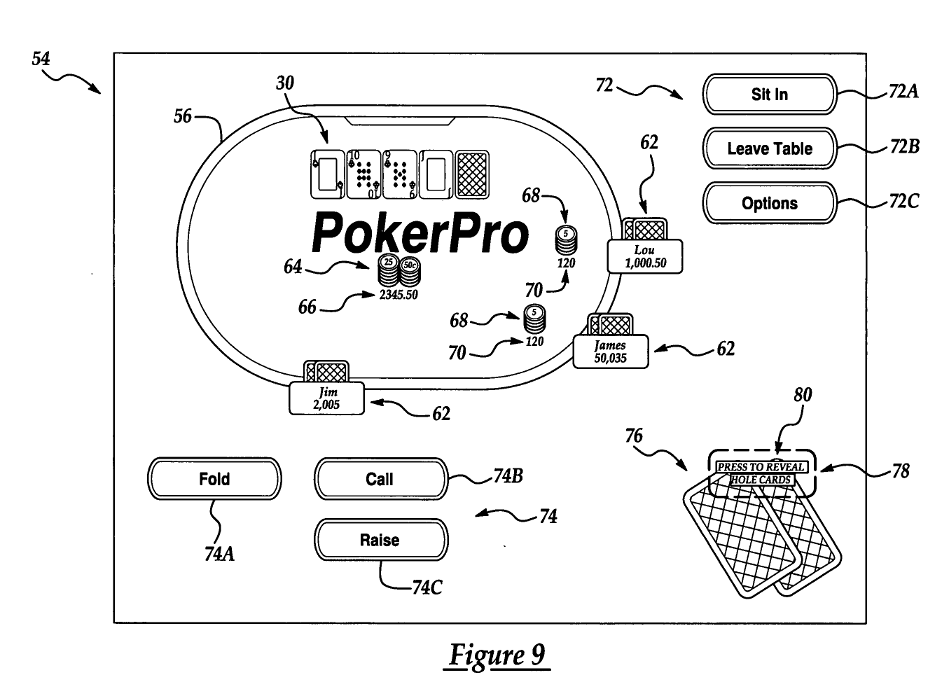

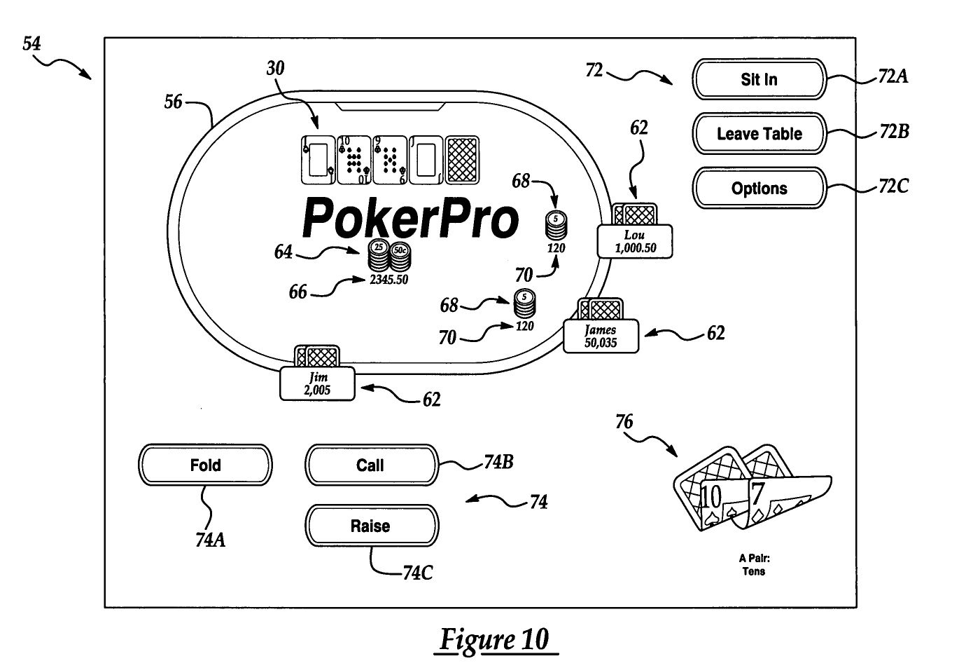

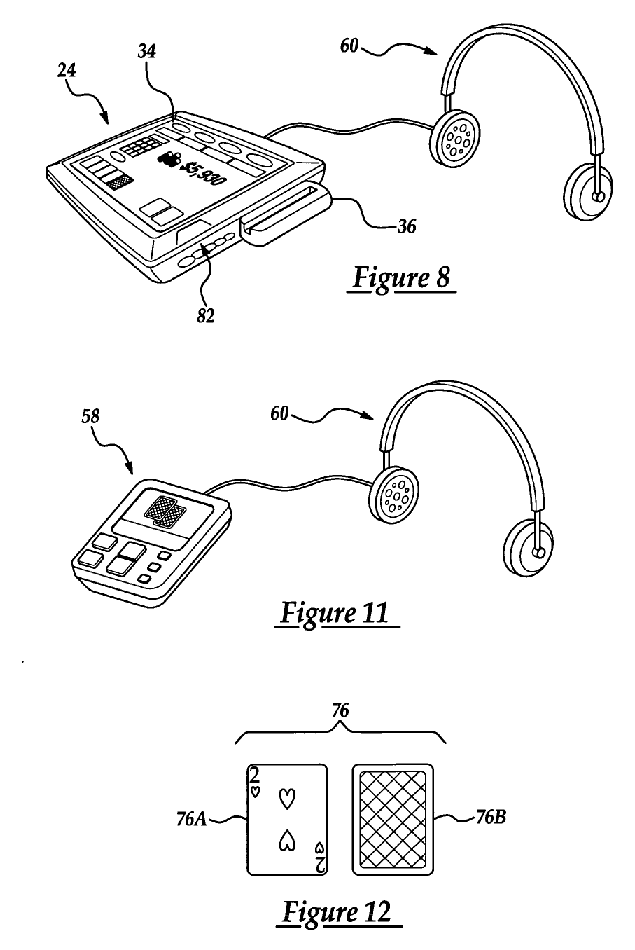

With reference to FIGS. 9 and 10, each electronic player interface area 24 implements a player interface 54. The player interfaces 54 may be implemented on the table top 20 (see above), or in the module 34. In another embodiment, the player interface 54 may be implemented on a hand-held device 58, such as a personal data assistant (PDA).

The player interface 52 may be graphical in nature (as shown in FIGS. 9 and 10), or may take other forms, such as a simple textual format. In one embodiment the electronic player interface areas 24 provide the player with the option of choosing between several player interfaces 52, such as a graphical representational of an electronic poker table 56 or the text interface.

Returning to FIGS. 9 and 10, in one embodiment the player interface 54 includes a graphical representation of a poker table 56. Each player in the poker game may be represented by a user graphic or icon 62, which may list their names as well as their chip totals. The pot of the current hand may be represented in the center of the poker table 56 by stack(s) of chips 64 and/or a number 66 representing the value of the current pot. Each player's contribution to the pot may be represented by stack(s) of chips 68 and/or a number 70 adjacent their user graphic 62.

The player interface 54 may also includes a series of player option buttons 72 and a series of game buttons 74. The player option buttons 72 may include, for example, a sit in button 72A, a leave table button 72B, and an options button 72C. Generally, only one of the sit in button 72A and the leave table button 72B would be active at any time. The options button 72C allows the player to access an option menu or screen (not shown) which allow the player to modify certain parameters of the player interface 54, such as, for example, to choose between different formats of the player interface 54. The series of game buttons 74 allow the player to signal their game play decisions to the system 10 during the play of the game. The game buttons 74 may include a fold button 74A, a call button 74B and a raise button 74C. These typically would only be active when it is a player's turn in the poker game. In one embodiment, the buttons 72 are implemented on the touch screen display devices 32. In an alternative embodiment, the buttons 72 are embodied in electromechanical switches or buttons (not shown).

In one embodiment, the player interface 34 may also include the community cards 30. Other information which may be displayed on the player interface include, but is not limited to indicator of the player whose turn it is, a total of chips for each player, any cards of the other players which are face-up, and/or messages to the player, such as advertising.

In another aspect of the present invention, the player interface 54 includes a graphical representation of one or more of electronic playing cards 76 (see FIG. 12). Each electronic playing card 76 has a front side 76A and a back side 76B. The back side 76B of each card has an identical pattern or image such that the cards cannot be told apart when viewing the back side 76B. The electronic playing card 76 is typically one of a set or deck of standard playing cards. The deck may be a standard deck of 52 cards, each card having a value. The value being two components: the first component being one of a two through ACE and the second component being one of four suits (hears, diamonds, clubs, spades). The value of each card is indicated on the front side 76A of each playing card 76.

The image displayed on the back side 76B of the playing cards may be a logo, a random image (chosen from a set of predetermined images), or may be advertising directed at the player. The image may include a video. In one embodiment, the image displayed on the back side 76B of the playing cards may be cycled through a set of predetermined images. The image may be selectable by a user, who may be the player or an employee of the casino.

In one embodiment, the electronic playing card or cards 76 are a player's hole card(s) in an electronic poker game. However, the electronic playing 76 cards may be used in any sort of electronic card game in which it is desirable to controllably display/hide the player's cards. Thus, while the present invention may be described below in the context of an electronic poker game (and more specifically, with respect to a player's hole cards in a Hold'em style poker game), the present invention is not limited to such a card game.

In a playing card game with physical cards, in which the player's card are dealt “face-down” and not revealed to any other player, the player may look at their cards, while attempting to keep the cards secret from the other players in several ways. For example, the player may lift the cards close to their bodies, spread them out, and shield them with their hands, so only the player can see the front side of their cards. Or the player may leave the cards face down on the table and lift one side or corner revealing at least a portion of the front side, while shielding the cards with their hands.

A controller, which is either, the module 34, the personal computer 52, the hand-held device 58, the server 50 or a combination thereof, controls the player interface 54, i.e., controls the information components of the player interface 54 displayed on the electronic player interaction areas 24, detects touches on the touch screen display devices 32 (when utilized) and interprets the touches as trigger or touch events (see below). As discussed below, the controller 24, 52, 58, 50 may control the display or obscuring (hiding) of the player's hole electronic playing card(s) such that the player may controllably display and view the cards, while maintaining them secret from the other players. As if the player was playing with physical playing cards, the player, thus, has the opportunity to shield their cards with their hand or hands prior to them being revealed.

In one aspect of the present invention, each electronic player interaction area 24 is assigned to a player. Once the player is assigned is to a particular seat at a table 18, the associated EPIA 24 may set as inactive or locked and may indicate the assigned player's name. Once the EPIA 24 is locked, the assigned player must login to the EPIA 24 (see below).

Once the player log-ins, the EPIA 24 becomes active and the player interface 54 is displayed. Also, since the EPIA 24 is active, the player may enter or sit-in on the game being player at the table 12 or adjust/modify any available options by actuating the options button 72C.

In one embodiment as discussed above, the EPIAs may be implemented using a separate or modular computer 34. In one embodiment, the modular computer 34 includes a display 32 which may be a touch-screen display 34. The touch-screen display displays information (text and/or graphics) regarding the play of the game and implements buttons or selectable areas on the EPIA 24 for user input.

A player may log-in to the system 10 or table 18 through the EPIA 24. In one embodiment, the player may log-in to the system using a player tracking card. The player swipes their player tracking card through the card reader 36. The EPIA 10 may also require entry of a PIN into an attached keypad or keypad implemented on the touchpad display device 34. Alternatively or in addition, the player may log-in using a biometric parameter, such as a fingerprint, sensed by a sensor and a RFID card or chip.

In one aspect of the present invention, the EPIA 24 includes a sound generation device which is used to generate sounds audible to the player assigned to the EPIA 24. The sound generation device may be implemented as an earpiece or headphones or one or more speakers. Generated sounds may be categorized as system sound or player sounds. System sounds include sounds which are intended or suitable to be heard by everyone, including other players and non-players. Player sounds include sounds which are intended to be heard, but not necessarily only, by the player. Example, system sounds may include sounds imitating the shuffling of cards, the dealing of cards, chips thrown into the pot, sounds related to the winning of the jackpot. Player sounds may include a reminder or indication of a player's turn or if the game is timed, an indication of the time remaining or that time is running out. Player exclusive sounds are sounds that can or should only be heard by the player and may indicate an audible signal indicating the player's hole cards or the highest hand of the player or a winning percentage associated with the player's hand.

In another aspect of the present invention, the EPIAs 24 may be implemented via a touchscreen display device 32. The devices 32 may be integrated with a computer in a module. Alternatively, the touchscreen devices 32 may be separate devices controlled by separate computers or the computer 52 at the table 18 or the server 50.

In many gaming environments 12, such as a poker room at a casino, a portion or percentage of each pot goes to the house for running the poker game. This portion of the pot is known as the rake. In one embodiment, the amount of the rake corresponding to the current pot is displayed on each EPIA 24. The rake may be shown as an amount in dollars and may include a graphical representation of virtual chips.

In one aspect of the present invention, the system 10 utilizes both virtual or electronic chips and virtual playing cards. In one embodiment, the EPIA 24 may include a graphical representation of the chips and/or a dollar amount indicative of the amount of chips each player at the table has remaining. Additionally, the EPIA 24 may include a graphical representation of the chips and/or a dollar amount indicative of the amount of the current pot. The pot may be shown in the middle of a graphical representation of the poker table.

In one embodiment, each EPIA 24 may also include a graphical representation of the community cards in the middle of the graphical representation of the poker table. Graphical representations of the other player's card may also be shown (face down during the current hand and face-up at the end of the hand).

As discussed above, system 10 may require that the player log-ins to the EPIAs 18 which is open or to which they have been assigned. The log-in may be accomplished in a variety of ways (see above). Once a player's identity has been established, however, the player can access a player account, purchase chips using an account balance. Additionally, information regarding the player's play at the table may be tracked and recorded to the player's account. For example, in one embodiment all transactional information related to one or all of the players' is tracked. All of the record or tracked information may be reviewed at the host console 102.

The EPIAs 18 may be provided with an Ear- or head-phone to provide the sounds (see above) or other signals to the player.

In one aspect of the present invention, the sounds provided by the EPIA 24 (see above), are provided using a simulated voice.

In one aspect of the present invention, the system may utilize a cashless system, such as Ticket-In Ticket-Out or “TITO” (see below)

In one embodiment, the system 10 requires that each player has a player account. The player account may have an associated balance which contains a dollar amount based on an amount of money deposited by the player and/or any winnings that they have collected, either through poker or some other game. Once a player has been identified by the EPIA 24, the player may download a dollar amount and purchase chips to play.

Alternatively, a ticket (with for example a barcode), magnetic card, RFD card, or some other media (jointly referred to as a TICKET) may be inserted in the EPIA 24. The TICKET may have an associated value which is either printed and/or encoded thereon or which is associated with the TICKET in the system 10.

Additionally, once the player decides to leave the table 18, any remaining chips they have, may be instantly converted back into dollars and stored in their player account and/or a new Ticket may be generated.

In another aspect of the present invention, each EPIA 24 may provide an indication of whose turn it is to act. If it is the player's turn who is assigned to an EPIA 24, then the EPIA 24 may provide an appropriate signal, such as a icon, either next to their name or anywhere on the EPIA 24, a sound such as a beep or musical tones, and/or a voice message. If it is a another player's turn, the EPIA 24 may indicate whose turn it is by an icon and/or flashing text, e.g., adjacent the player's turn.

As discussed above, the EPIA 24 includes a set of player option buttons 72 which allow the player to take an appropriate action, such as wager, fold, or call, during their turn. In one embodiment, the EPIA 24 only activates those buttons 72 which are appropriate, given the rules of the game being plated, during the current turn. For example, if the maximum number of raise for a particular game have already been made, then the wager or raise button would be inactive. Additionally, all of the buttons 72 will be inactive when it is not the player's turn.

As discussed above, each seat or EPIA 24 is assigned to a particular player. The player may be assigned to a seat off a queue using a queue system or may be assigned by an employee of the casino using the system 10. However, under certain situations, the player may desire to changes seats or move to another table. For example, if another player or players have left the table leaving fewer players at the table and the player does not like to play at a table with that few of players, the player may request through the EPIA 24 another seat assignment.

The present invention includes methods for displaying and/or obscuring a player's hole cards (see above). Additionally or separately, the EPIA 24 may be adapted to provide an indication of the winning percentage based on the player's current hand and the community cards. The winning percentage may be shown textually, e.g., 55%, and/or graphically, e.g., a pie-chart or bar chart. The winning percentage may be triggered and shown using the same trigger event associated with the hole cards. Alternatively, a separate trigger event, such as a touch-event on another location on the EPIA 24 may be used to show the winning percentage.

The present invention includes methods for displaying and/or obscuring a player's hole cards (see above). Additionally or separately, the EPIA 24 may be adapted to provide an indication of the player's current highest hand based on the player's current hand and the community cards. The highest hand may be shown textually, e.g., two-pairs, and/or graphically, pictures of the five cards which make of the highest hand. The highest hand may be triggered and shown using the same trigger event associated with the hole cards. Alternatively, a separate trigger event, such as a touch-event on another location on the EPIA 24 may be used to show the highest hand.

1. Utilizing Surface Acoustic Wave touch screen technology

2. Utilizing Multi Touch touch screen technology

3. Player away feature: Allows a player to press a button to temporarily remove himself from the game. Secure process for returning him to game accounting for missed blinds.

4. User customizable views of the game: Allow many views of the game and method to allow user to select preferred view.

5. Integrated with speakers

6. Method to obscure player pre-selection of one or several bet options: Poker is a sequential game. Situations exist where a player will know what action they want to take prior to it being there turn. Allowing the player to make that decision in advance of their turn in a way that allows players seating close to observe this action would provide an unfair advantage to some players and not others. This feature allows a player to make a pre-selection while observing his hole cards in such a way that other players will not be able to observe that pre-selection.

7. Ability to display live and pre-recorded Video

As discussed above, a poker table 18 may include one or more EPIAs 24. For example, each poker table may have 11 seats and accommodate up to 11 players. Each EPIA 24 may have one or more of the features described in IV.

In one embodiment as discussed above, the EPIAs may be implemented using a separate or modular computer 34. In one embodiment, the modular computer 34 includes a display 32 which may be a touch-screen display 34. The touch-screen display displays information (text and/or graphics) regarding the play of the game and implements buttons or selectable areas on the EPIA 24 for user input.

In one embodiment, the modular computer 34 includes a display 32 which may be a touch-screen display 34. The touch-screen display displays information (text and/or graphics) regarding the play of the game and implements buttons or selectable areas on the EPIA 24 for user input.

In one aspect of the present invention, the table 18 includes a table sound generation device which is used to generate sounds audible to the players. The table sound generation device may be implemented one or more speakers mounted to integral with the table 18. Alternatively, the table sound generation device may include one or more speakers adjacent to or integral with each EPIA 24. Generally, the sound generation device plays system sounds or player sounds which are suitable for every player to hear.

For example, system sounds may include sounds imitating the shuffling of cards, the dealing of cards, chips thrown into the pot, sounds related to the winning of the jackpot. Player sounds may include a reminder or indication of a player's turn or if the game is timed, an indication of the time remaining or that time is running out. Generally, player exclusive sounds will not be player through the player sound generation device.

In one embodiment of the present invention, the poker table 18 includes a central display area 26. As discussed above, the individual electronic player interaction areas 24A-24J are used to convey game information directly to a player assigned to a specific player interaction area 24A-24J and to implement a player user interface to effectuate interaction or input from the player. The central or common display area 26 is used to display information to all of the players.

The common cards 30 are displayed in the central or common display area 26.

In one embodiment, the central display area 26 is implemented in a separate display 38, such as a LCD or plasma monitor or similar device. The remainder of the table top may be covered in a material such as felt, or more specifically, green, blue, or red felt. Logos, game information, or other information may be printed on the material.

As discussed above, the common cards 30 are displayed in a larger size than the hole cards 26 are displayed at a first predetermined ratio and the common cards 30 are displayed at a second predetermined ratio. The first and second predetermined ratios may be expressed as a ratio of a standard size playing card or a predetermined default size. In one embodiment, the first and second ratios are the same. In another embodiment, the first and second ratios are different. For example, the first and second ratios may be defined such that the common cards 30 are displayed larger than the hole cards 28.

In an alternative embodiment, the electronic player interaction areas 24 and the central display area 26 may be implemented in a single display which covers a large portion of the table top. The electronic player interaction areas 24 and the central display area 26 may be set apart from the rest of the table top 20 by virtual borders. The areas of the display around the electronic player interaction areas 24 and the central display area 26 may be used to simulate the table top of a standard poker table, e.g., an image of material, such as green felt, may be displayed. Furthermore, logos, game information, other information, advertisements, announcements, pictures, videos, or other information may be displayed, rotated, cycled, or displayed for a limited period of time on the table top 20.

Typically displays, such as LCD or Plasma monitors are rectangular in form. As shown in Figure, the overlay may be integral with the table top 20 and may include a cut out. The overlay covers the outer edge of the display. Only the portion of the display inside the cut-out is visible. In the illustrated embodiment, the cut out has a shape, such as an oval shape, which is similar to the shape of the table.

As discussed above, the rake is defined as a portion or percentage of each pot that goes to the house for running the poker game. This portion of the pot is known as the rake. In one embodiment, the amount of the rake corresponding to the current pot is displayed on the central display area 26. The rake may be shown as an amount in dollars and may include a graphical representation of virtual chips.

In another aspect of the present invention, the central display area 26 may provide an indication of whose turn it is to act. In one embodiment, the central display area 26 may provide an appropriate signal, such as a icon, e.g., an arrow or other symbol, a sound such as a beep or musical tones, and/or a voice message. This indication of a player's turn may be in addition to the indication on the EPIA 24.

During a poker hand, even at a standard poker table with a human dealer, one of the players is designated as the “dealer”, for the purposes of the order in which the playing cards are dealt and in which wagers are made. In one aspect of the present invention, the central display area 26 may provide an indication of which player is designated the “dealer” for the current hand. In one embodiment, the central display area 26 may provide an appropriate signal, such as a icon, e.g., an arrow or other symbol. This indication of a player's turn may be in addition to the indication on the EPIA 24.

As discussed above, the hole cards 28 are displayed face-down on the respective electronic player interaction area 24 and the common cards are displayed in the central display area 26. In one aspect, the common cards 30 are displayed at a larger size than the hole card 28.

In one embodiment, the hole cards 28 are displayed at a first predetermined ratio and the common cards 30 are displayed at a second predetermined ratio. The first and second predetermined ratios may be expressed as a ratio of a standard size playing card or a predetermined default size. In one embodiment, the first and second ratios are the same. In another embodiment, the first and second ratios are different. For example, the first and second ratios may be defined such that the common cards 30 are displayed larger than the hole cards 28.

In one aspect of the present invention, the table 18 provide a poker game, such as Texas Hold'em for the players. In one embodiment, the provided poker game is a timed game, i.e., the player's have a predetermined time period in which to complete each turn. For example, the player's have a set period of 1 minute to complete each turn. Alternatively, the period of time may vary based, e.g., the first turn may have a period of completion of 1 minute, while the second turn may have a shorter or longer period of completion

In another aspect of the present invention, the central display 38 may be used to display advertising messages. The advertising messages may be from the casino or third parties and may consist of graphics, pictures, animations, video and/or audio. The advertising may be presented at specific location on the central display 38 and may be varied, based on time, i.e., cycled through a set of advertising messages.

8. Display and/or animation of blinds on Central Display Area 26

9. Display and/or animation of community cards on Central Display Area 26

10. Display and/or animation of bets placed and player chip stacks on Central Display Area 26

11. Indication of players who have folded and not folded on Central Display Area 26

12. Display and animation of winning hands on Central Display Area

13. Central Display Area 26 utilizing transducer sound emitting technology eliminating the need for separate speakers

14. Display on Central Display Area 26 of wining hand percentage estimates in situations where all remaining players cards are exposed e.g. remaining players are all in.

In one aspect of the present invention, the poker tables 18 in the system 10 are networked and connected to one or more servers 50. The server 50 may be used to implement and facilitate, player tracking, ticket in ticket out (cashless) wagering, assigning player's to a seat at a particular table, tournament play, table set-up (including turning the tables on and off and modifying table parameters), and progressive jackpots. Each table 18 may have one or more EPIAs 24. The poker tables 18 and the EPIA may have one or more of the features described in VI.A. and VI.B.

In addition, other devices may be connected to the server 50 for providing additional features and/or functions. For example, a queueing system may be provided (see below). This system may be implement using a separate computer which implemented this function. The separate computer may also implement other features or functions of the system. It should be noted, however, that in some systems, these additional features or function could be provided, at least in part, by the server(s) 50.

In one aspect of the present invention, the server 50 runs the games. In other words, the server 50 electronically “shuffles” the playing cards, deals the cards, controls the players' turns, receives the player's inputs and acts accordingly, tracks, manages, and awards the pot, tracks the rake, etc. . . . Game data is stored in a database. Each input, wager, play, etc. . . . is stored in the database.

In one aspect of the present invention, a queueing system assigning player's to seats at a poker table 18 is provided. The queueing system may also implement a waiting list if there are no seats available. In one embodiment, one or more devices, such as a personal, notebook, or tablet computer, handheld computer, or PDA, is accessible by one or more employees of the casino. The device(s) allow the employee(s) to enter a customer's name or player ID or to swipe the player's ID Card. If there is a seat at a table 18 available, the player may be assigned to the seat.

If there is more than one seat available, in one embodiment the employee, may select one of the seats (with or without input from the player). Alternatively, the device may select the seat using a predetermined set of rules.

If there are no seats available, the player is placed in a queue, until a seat opens up. In one embodiment, players are taken off of the queue and assigned a seat on a first come, first served basis. However, the system 10 may allow the casino to implement special rules for players to bypass the queue or list. For example, the casino may present vouchers to players under certain conditions, such as a win in a tournament, to be placed at the head of a queue.

In one aspect of the present invention, the server 50 provides an interface which allows a user, such as an authorized or designated employee of the casino, to set-up a new table 18 or to modify the parameters of an existing table 18. The interface may be implemented on a server 50 or on another device networked to the server 50.

The interface may provide one or more of the following features: ability to turn a table on/off, and ability to change game parameters, such as the permitted wagers, the game being players, the rake, etc. . . .

In one aspect of the present invention, as stated above the system 10 tracks each transaction, wager, card dealt in a database. The system 10 also tracks the players which are playing at each table 10. This information is stored in the database, summarized, and may be presented in any numerous forms of reporting formats. Any information regarding the player's, the games, and how each hand is played may be tracked. This available data may also be analyzed for purposes of determining the frequency of poker hands (per hour) for a table or all games in which a particular player or players played or detecting, e.g., collusion between players.

As discussed above, in one embodiment every player must belong to a player club and have an assigned player ID card to log-in to an EPIA 24 to player poker at a table 18. Each player has an account in the player tracking club. The player's account in the tracking club tracks the amount of cash or money that the player has available for play at poker. The player's account also tracks the player's play at a poker table 18, including amounts wagered and amounts won.

The system 10 allows jackpots, i.e., progressive jackpots, to be generated by and won across multiple hands and/or multiple tables. A progressive jackpot may increase based on the amounts wagered and/or won at the included tables. The progressive jackpot may continue to increase until won under a set of predetermined conditions. Alternatively, it may be active until only for a predetermined time period. The conditions for winning the jackpot that it is won by one or more players at the end of the time period.

The system 10 allows a progressive jackpot to be funded in multiple ways. The way in which a progressive jackpot is funded may be funded through a computer program application on the server 50 or other device. For example, the progressive jackpot may be funded by taking a set percentage from every jackpot, every other jackpot, or every n^{th} jackpot.

The amount of the progressive jackpot may be displayed on the central display 38 and/or a remote display.

The progressive jackpot may be initiated randomly, under certain defineable conditions, and/or for a specific event, i.e., a marketing event. The progressive jackpot may be a single hand (across mutipled hands), a predetermined number of hands at one table or across multiple hands, for a predetermined time period, etc. . . .

15. Progressive, side-bet, Double-Up, Mystery and many other jackpot techniques are well understood in relation to slot machines. Methods and systems to apply those techniques in combination with an automated poker table.

16. Displaying Gov't Reporting Form in EPIA

In another aspect of the present invention, after a jackpot is won by a player, one or more government reporting forms may be presented to the player on their EPIA 24. The form may accept the player's electronic signature (if permissible) or may notify the player of the requirements and direct them to a location where they can fill out the form. The device may be a personal, notebook, or tablet computer, handheld computer, PDA, or other suitable device.

In one aspect of the present invention, one ore more employees of the casino may be assigned to manage a plurality of tables. One of the employees may manage the queueing system (where provided). A device, networked to the server, may be provided which provides various functions to the employees. The device provides a dashboard application which allows the employee to manage various aspect of the tables 18

In one aspect of the present invention, the employee may view various data related to the current state of a table, including, but not limited to, the players, the pot, wager information, the common cards, etc. . . .

The employee, for example, in response to an in-person query or a quiry made through an EPIA 24, may view tracked data to look for evidence of collusion between two or more players. For example, the employee may determine if two or more persons at a particular table have a habit of playing at the same time and to determine if there is any pattern discernable in the play which would provide evidence that they are impermissibly working together.

In one aspect of the present invention, each EPIA 24 may provide a player with buttons which summon or direct specific employees of the casino. For example the player may request a host/hostess to order a drink. Additionally, the player may request that an employee review something that occurred or is occurring at the table 18, e.g., possible collusion. This may be done anonymously.

As described above, the device which allows the players to manage the tables 18, may also allow the employee to automatically or manually assign players to particular tables and/or seats and/or EPIA 24.

In one embodiment, the server 50 controls the advertising on the central display 38. Advertising may also be provided on the EPIA's 24 and/or a remote display associated with the poker tables 18. The server 50 may control the content, frequency, and/or the cycling of the advertising.

In one aspect of the present invention, a player may refrain from playing in one or more hands or get up from a table and not play in one or more hands. Typically, however, if the player decides to play a subsequent hand, than the player owes the current pot a predetermined amount, i.e., the “blind”, per hand missed. In one embodiment, if the player decides to sit-out one or more hands, then the system 10 tracks the number of hands missed and automatically deducts an amount equal to the number of hands missed multiplied by the blind once the player decides to play another hand.

As discussed above, the system 10 records every transaction, card dealt or played, wager, etc. . . . in a database. This allows the system 10 to recover from any error and put the game back into the same state.

The system 10 facilitates tournament play. In a tournament, a predetermined number of tables 18 having a predetermined number of players are involved. A buy-in, e.g., $100 is required. Typically, after a player loses all of their money, they are eliminated from the tournament.

Under predetermined rules, players may register for a tournament and be assigned to seats at a table. During play, under predetermined rules, tables may be broken down and the players distributed to other tables. The system 10 facilitates the tournament by providing one or more of the following features:
a) Registration
b) Tracking tournament information
c) display of tournament information on central display and/or remote display
d) tournament set-up, e.g., buy-in
e) Re buy-in
f) tournament jackpot, cash or entry voucher for entry another tournament (specific tournament or expiration date)
g) Process for breaking tables
   (1) message that table is breaking
   (2) convey new seat assignment
   (3) determination of breaking order
   (4) display of breaking order
h) display information on status of other tables and players at other tables
i) System to monitor and adjust hands per hour of an individual table during a tournament: During a poker tournament it is important that each table play roughly the same number of hands per hour as all other tables. This can be accomplished by pausing a game and/or slowing a game down with out pausing.
j) Multi-site tournaments.
k) System for automatically paying players tournament winnings based on tournament pay tables and their final position in the tournament.

17. Automatic posting of blinds and method to turn on and off of automatic posting of blinds/missed blinds.

18. Method for automatically calculating allowed bet amounts in pot-limit and no-limit betting structures.

19. Automatic varying of rake based upon number of players, amount of pot, time of day, type of game and/or other criteria.

20. Ability to offer rake discounts to individual players.

21. Transferring a player from one seat to another at the same table, or to another: Situations exist where are forced to (“must move”) or desire to move seats. This feature provides automatic notification and movement of player information from one seat to another.

22. Database and network architecture allowing single and multi-site networking and management of a plurality of automated poker tables.

23. Tracking and reporting of player statistics: Data and method of display over the internet and/or other methods for player to analyze their previous play statistics. In another embodiment date and method of display is utilized to determine player rankings for a given game and/or over a given time period

24. Ability to view available tables and register for live tables and/or tournaments via a remote connection such as the internet or an automated voice response unit.

25. Options adjust speed of play(speed of card shuffling, dealing, discarding, betting, etc etc)

26. Electronically transfer money from an account to the table

27. Electronically transfer money to another

28. Use of “cash card” to bring money to the table.

29. Ability for operator to view details of any and all tables

30. Ability for operator to view details of any and all players

In one aspect of the present invention, remote or virtual games may be provided by the system 10. The remote or virtual games may be provided on wireless devices and may be played at predetermined locations.

Virtual games may also be provided through the EPIAs 24. For example, the virtual or remote games may be played by the poker players when it is not their turn. The virtual or remote games may be another poker hand, played against other players, at the table or at other tables, or played against virtual players. Alternatively, the remote or virtual games may be other types of games, including, but not limited to blackjack, keno, slot machines, etc. . . .

In addition to running other casino games on EPIA 24 or other terminals, system can be run on other gaming devices throughout the casino. For example, a virtual poker game can be run on an existing electronic bingo terminal or an electronic race book terminal.

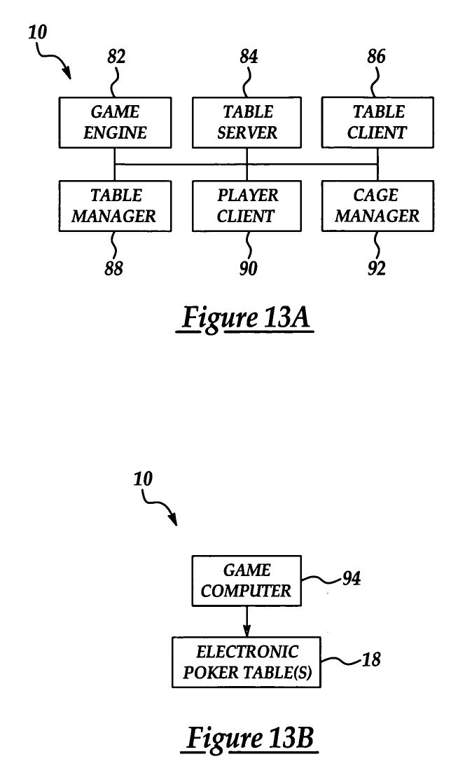

With specific reference to FIG. 13, in one aspect of the present invention, the system 10 includes an electronic poker table 18 for providing an electronic poker game to a plurality of players. As discussed above, the electronic poker table 18 may be a stand-alone table, or may be one of a plurality of electronic poker tables 18 located, for example, in a poker room 14 of a casino.

As discussed above, in one embodiment the electronic poker table 18 includes a table top 20 with a playing surface 22 and a plurality of electronic player interaction areas 24 which are located around a periphery of the table top 20. Each electronic player interaction area 24 includes a player interface 54 for interaction with one of the players.

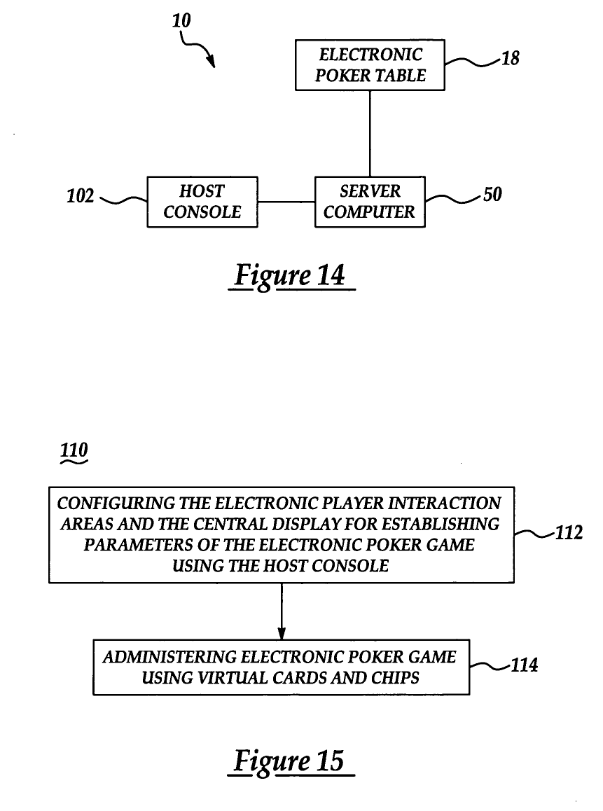

With particular reference to FIGS. 14 and 15, in one aspect of the present invention, the system 10 includes a console 102 coupled to the server computer 50 for configuring the electronic player interaction areas 24 and/or the central display area 26 and for establishing parameters of the electronic poker game.

In one embodiment, the host console 102 is embodied in a separate computer, such as a personal computer, connected or networked to the server computer 50. The host console 102 may be integrated into a console, such as a kiosk. The host console 102 may also be embodied in any type of suitable device, such as a handheld computer, a personal digital assistant (PDA), notebook or laptop computer, or tablet computer. In one embodiment host console 102 includes a touch screen display.

In one aspect of the present invention, the host console 102 is an administrator device which includes functionality for the creation and editing of game profiles that include settings such as: game type, limits, play timing, and/or number of required players. The host console 102 allows the host or user to start, pause, and stop games and to monitor table play. New tables can be created, opened, and ring or tournament games can be easily started.

In one embodiment, the host console 102 provides the ability to turn the at least one electronic poker table 18 on and off. For example, as discussed above, the electronic poker tables 18 may include one or more computers for running/driving the electronic player interaction areas 24 and/or the central display area 26. The host console 102 may allow a user to turn these computers on and off, as well as other devices associated with the electronic poker table(s) 18.

As discussed above, the electronic poker tables 18 may play one or a plurality of poker games. Each poker game will generally have its own sets of rules, including the number of cards, how the cards are dealt, the number of betting rounds, the structure of permissible wagers, etc. For example, the electronic poker tables 18 may be designed to provide a “flop” type poker game, such as Texas Hold'em. The basic rules of Texas Hold'em are discussed above. In one aspect, the host console 102 allows a user to select or change one of the plurality of poker games to be played on one or more of the electronic poker tables 18.

In another aspect, the host console 102 may allow a user to select the betting or wager structure to be used. For example, the poker games may have one of a limit, no-limit, or pot-limit wagering structure. The host console 102 may allow the user to set the wagering structuring for a given electronic poker table 18.

Furthermore, the host console 102 may allow the user to select or change other parameters of the electronic poker games, including, but not limited to time parameters, wager limits, amounts associated with a big blind and a little blind.

In one embodiment, the host console 102 allows a user to select whether the electronic poker game is a timed game or a non-timed game. In a non-timed game, there is no time limit in which a player must make a decision during their turn in a betting round. In a timed game, the player must choose a course of action during a predetermined time period. For example, during a given betting round, the players may have a predetermined period of time to either fold, check, or make a wager. If no action is taken during the predetermined time period, the server computer 50 may take a predetermined default action, such as folding or checking. Generally, the time period for response during a betting round will decrease as the hand of the electronic poker game progresses. Parameters, such as the predetermined time period for each betting round may be modified by the host console 102.

In another aspect of the present invention, the electronic player interaction areas 24 may allow a player to order drinks. This may be done, for example, through selection of the options button 72C which would bring up a dialog or another menu. A player may order a drink directly, or request a server. In response to the player ordering a drink, the host console 102 may monitor a number of drinks provided to the player.

In another aspect of the present invention, the host console 102 allows the host or user to add notes with information related to a specific player.

In still another aspect of the present invention, the host console 102 allows the host to replay one of the hands or the electronic card came, either graphically, textually, numerically. The replay of a hand may occur or be shown on the display of the host console 102 and/or the central display 38 and/or the display devices of the electronic player interaction areas 24. The host console 102 may allow the user to step through, play by play, each action or event in the hand being replayed.

The electronic player interaction areas 24A-24J may independently also provide this option. The replay option at the individual EPIAs 24A-24J may be limited, however. For example, the replay option may be limited to showing the end result of the last hand and may only be available for a short period of time after the end of the hand.

Other functions may be provided by the host console 102. For example, as discussed above, players may be assigned to one of the electronic player interaction areas 24. The system 10 may require that the assigned player log-in to the assigned electronic player interaction area 24. The system 10, possibly through the host console 102 or the server computer 50 allows a user to define a trigger event based on a particular player. The host console 102 may monitor the players who log on, and produce a signal if a designated player logs on. Thus, a user, in response to the signal is aware that the designated player is currently located and playing at the respective electronic player interaction area 24.

In another aspect of the present invention, the host console 102 may be used to monitor play at one of the electronic poker tables 18 and establish a value associated with the rate of play of hands at the at least one electronic poker table 18. This may be done by establishing when a hand of the electronic poker game is dealt and the time a winner is determined and the pot awarded to the winner. In one embodiment, if the rate of play of hands is below a predetermined value, then the user of the host console 102 may be signaled, e.g., via a message or alert (audio and/or visual) on the host console 102. In response, the user may wish to observe play at the electronic poker table 18.

Additionally, the host console 102 may allow the user to pause play at one of the electronic poker tables 18, for example, to allow the user to discuss any issues any of the players have with regard to the electronic poker game and/or one of the other players. The user may re-start the electronic poker game when finished.

The host console 102 may also allow the user to lock out and remove one of the players from the electronic poker table 18. The host console 102 may allow the user to adjust the stack of electronic chips for one or more of the players. This may be used, for example, to correct any deficiencies and/or settle any disputes with regard to operation of the electronic poker table 18 or play of one of the other players.

In another aspect of the present invention, the host console 102 may allow a user to restart the electronic poker table 18 after a fault or fault condition. For example, the host console 102 may allow the user to restart the electronic player interaction areas 24 and/or the central display area 26 (or table client). Additionally if the electronic player interaction areas 24 include a separate computer or a separate computer is provided to drive the central display area 36, the host console 102 may be adapted to restart or reboot these computers.

With particular reference to FIG. 15, in another aspect of the present invention, a method 110 provides an electronic poker game to a plurality of players on an electronic poker table 18 using a host console 102 and a server computer 50. In a first step 112, the host console 102 may be used to configure the electronic player interaction areas 24 and the central display area 26 and to establish parameters of the electronic poker game. In a second step 114, the electronic poker game is administered by the server computer 50 using electronic cards and chips.

In another aspect of the present invention, a player may create an alert to the host console through their EPIA 24. The alert may be anonymous. The alert is a request that the host come and observe a table. The alert appears on the host console 102. If the alert is anonymous, there will be no indication of which player created the alert on the host console 102.

In another aspect of the present invention, the host console 102 allows the user to “hibernate” a game. This may be used for example, to pause a game until the next day. A hibernated game may be re-started at the same table or any other table.

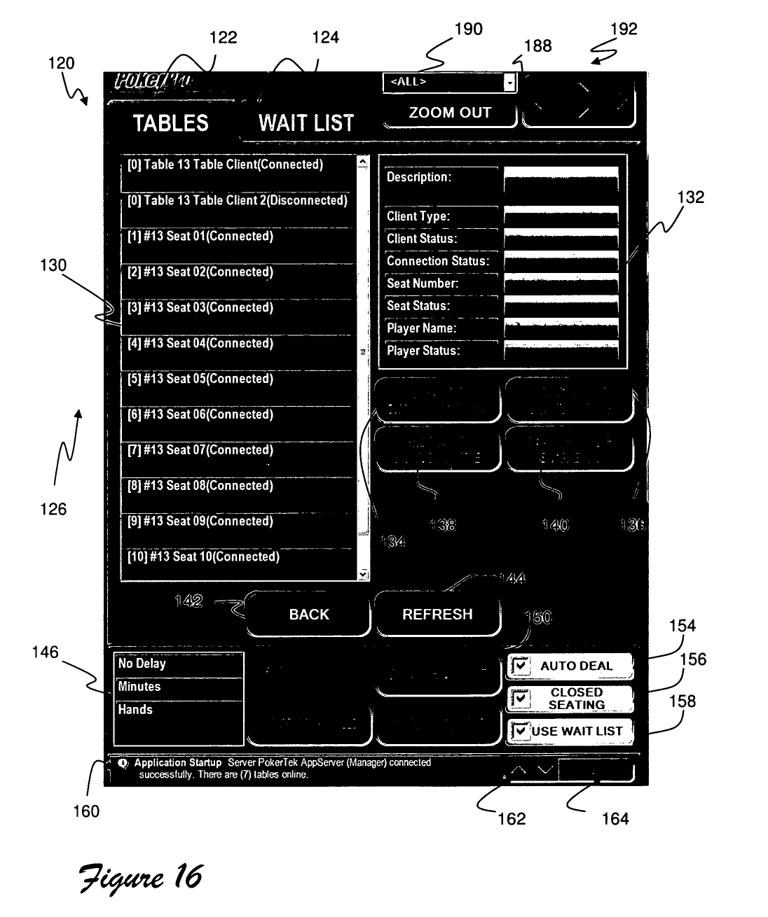

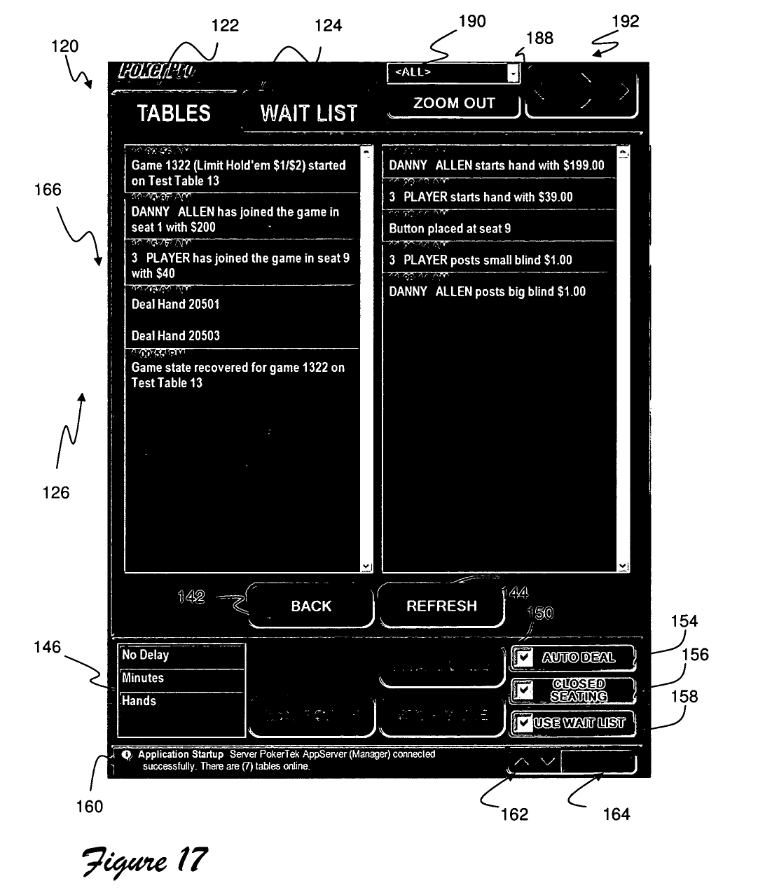

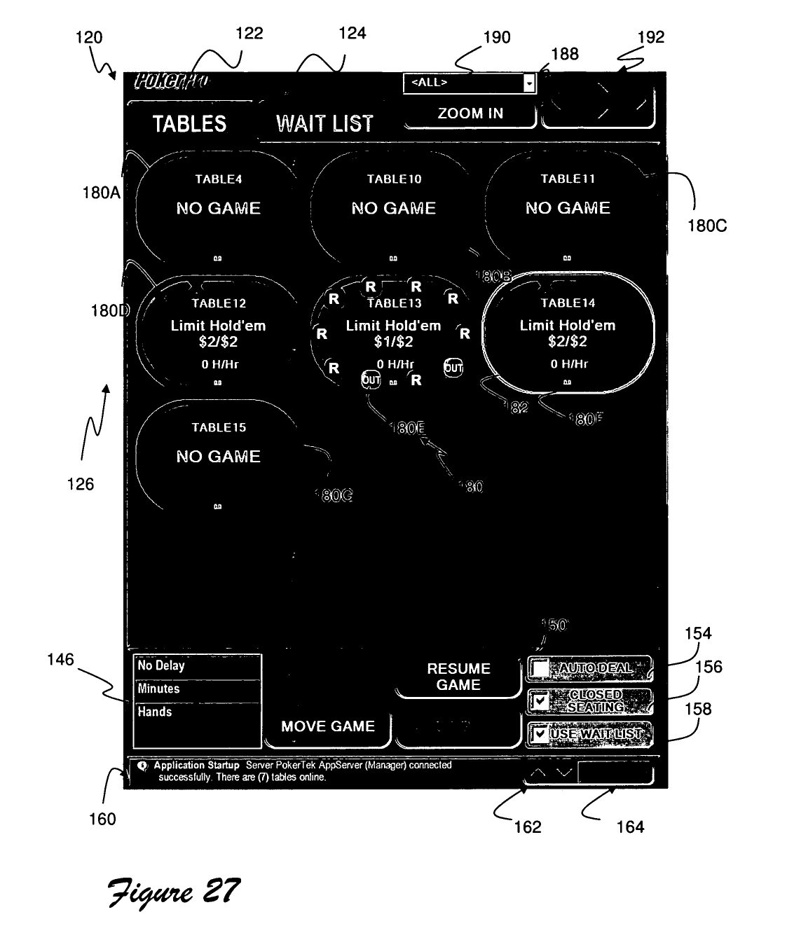

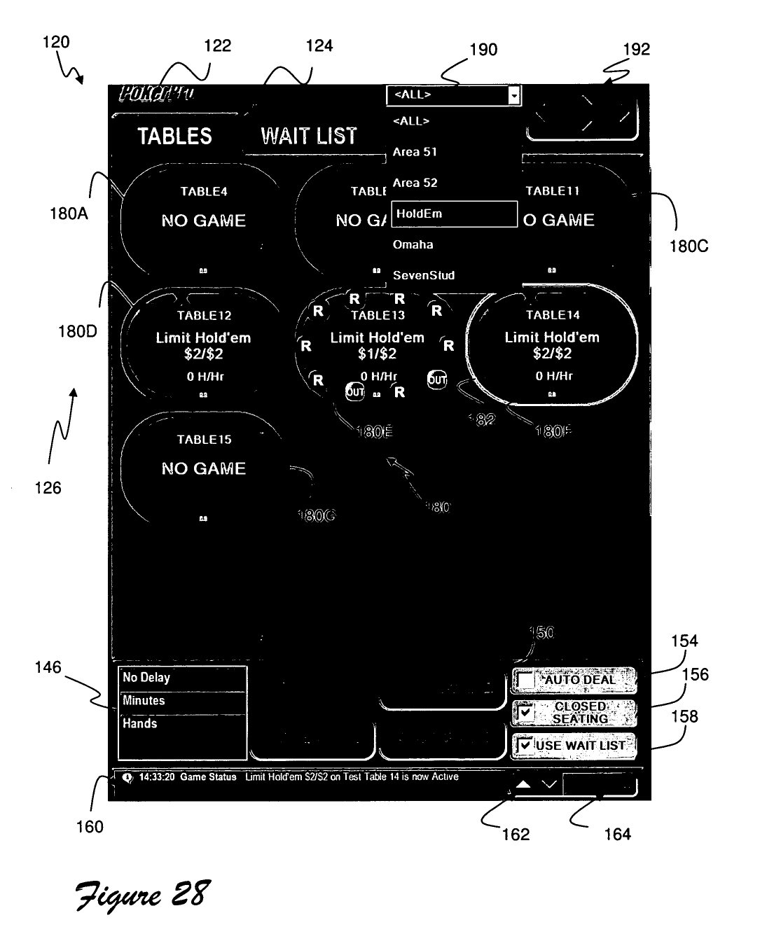

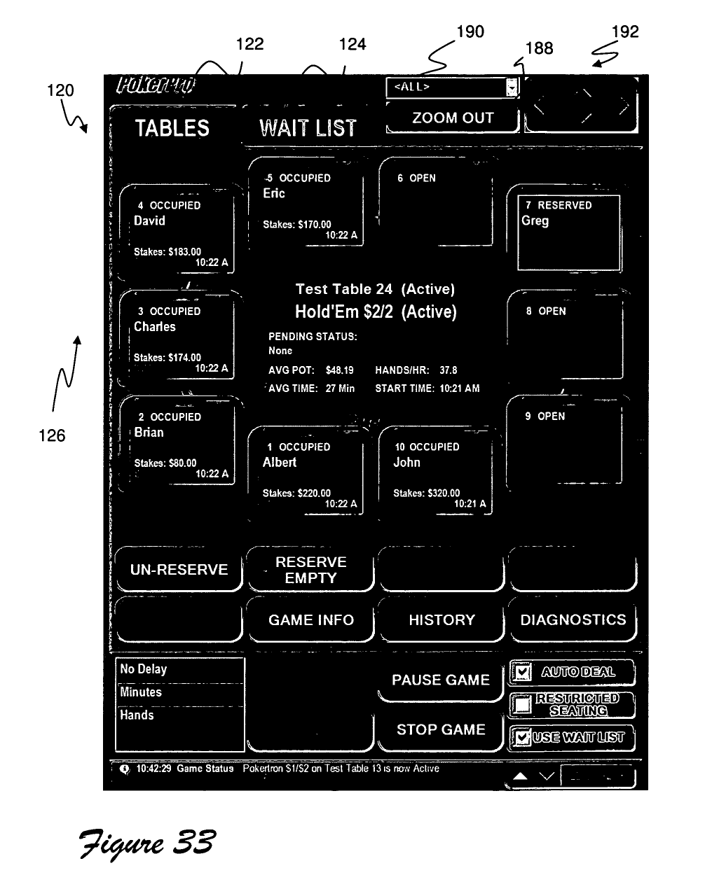

In one aspect of the present invention, the host console 102 implements a user interface 103 for use by an operator (not shown). With reference to FIGS. 16-36, exemplary screen shots of the user interface 103 for the host console 102 are shown.

The screen 120 include a table tab 122 and a wait list tab 124. Selection of the table tab 122 displays a table page 126 (as shown). Selection of the wait list tab 124 displays a wait list page 128 (see FIG. 29).

With particular reference to FIG. 16, each table 18A-18J maybe selected and diagnostic information and options are shown on the table page 126. In the illustrated embodiment the table page 126 includes a table component list 130, a component parameter list 132, a reset button 134, a restart software button 136, a reboot button 138, a calibrate screen button 140, a back button 142, and a refresh button 144.

The table component list 130 includes a list of all components of the selected table 118A-18J, each personal computer 50 (i.e., the “Table Client”) and each module 34 (i.e., the individual seats). Table Client 2 is a backup to Table Client 1. Selection of one of the components of the table 18A-18J in the table component list 130 displays information regarding the selected component in the component parameter list 132.

In the illustrated embodiment, the component parameter list 132 includes a:

1. Description Field (e.g., Table 13, Seat 4);

2. Client Type Field (e.g., Player or Table);

3. Client Status: (Active or Inactive);

4. Connection Status: (Connected or Disconnected);

5. Seat Number (where appropriate);

6. Seat Status (e.g., Open, Reserved, Active);

7. Player Name (when available); and,

8. Player Status (e.g., Active or In-Active).

The reset connection button 134 is active when the connection between the server computer 50 and the component selected in the component list 130 is disconnected. Selection of the reset connection 134 may be used to “ping” the selected component and attempt to restart the connection therebetween.

The restart software button 136 may be used to restart the software on the selected component if the component is inactive. For example, either the client software or the operating software may be restarted, i.e., a soft reboot.

The reboot hardware button 138 may be used to restart the selected component, i.e., turn off the selected component and turn the selected component back on.

As discussed above, the electronic player interaction areas 24A-24J may be implemented as touch screens. When such devices are used for the first time, or periodically, a calibration routine must be re-run. Selection of the calibrate screen button 140 will run the calibration routine on the selected component.

Selection of the back button 142 will return the screen 120 to a previous state or view. Selection of the refresh button 144 will refresh all of the information contained on the current screen.

The table page 126 also include a stop/pause parameter selection area 146, a move game button 148, a pause game button 150, a stop game button 152, an auto deal check button 154, a closed seating check button 156, a use wait list check button 158, an information/status area, a pair of navigation buttons, and a clear alert button 164.

The stop/pause parameter selection area 146 is used with either of the pause game button 156 or the stop game button 158 (see below), and in the illustrated embodiment, includes three options (No Delay, Minutes, Hands). The user may want to pause a game or table to make a change to the table or perform some other function. The game or table will be resumed when the user is finished. A stopped game ends the play at the table, e.g., at the end of the day.

The auto deal check button 154, the closed seating check button 156, and the use wait list check button 158 are used to turn on/off the corresponding function. For example, the use wait list check button 158 is used to

The information/status area 160 provides additional information about the selected component or a just completed action. The navigation buttons 162 may be used to across between messages in the information/status area 160. The clear alert button 164 is used to clear alerts which may be generated by players at their respective EPIAs 24A-24J.

With particular reference to FIG. 17, the table page 126 may also be used to display the game history of a selected table 18A-18J may also be displayed in a list 166. The list 166 includes a line item for each action that has occurred on the selected table, including a time stamp.

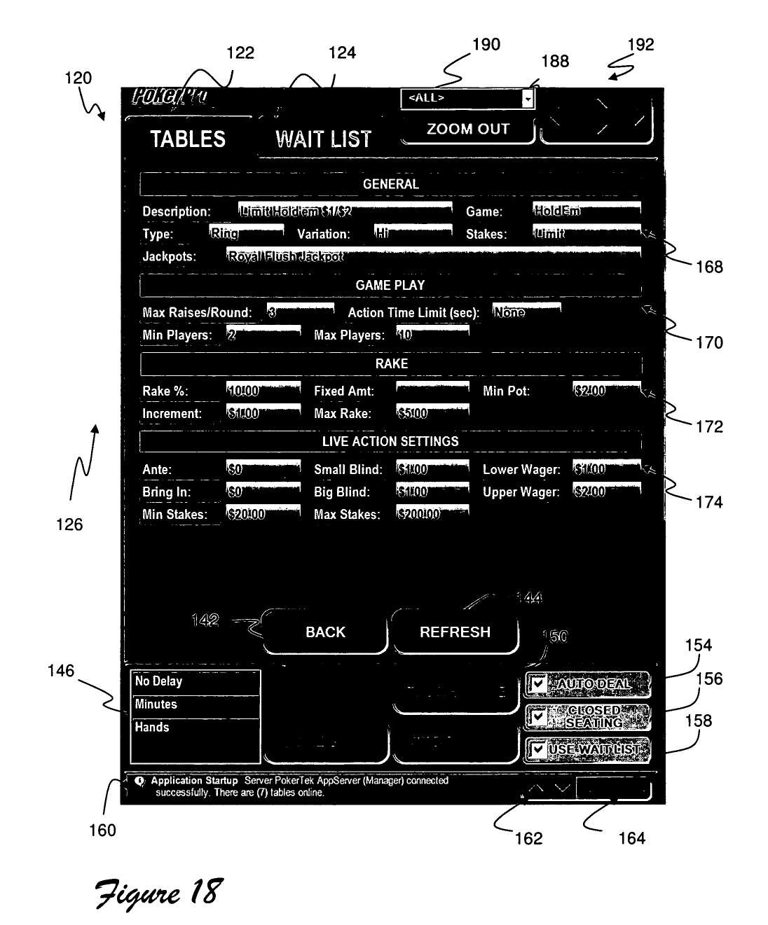

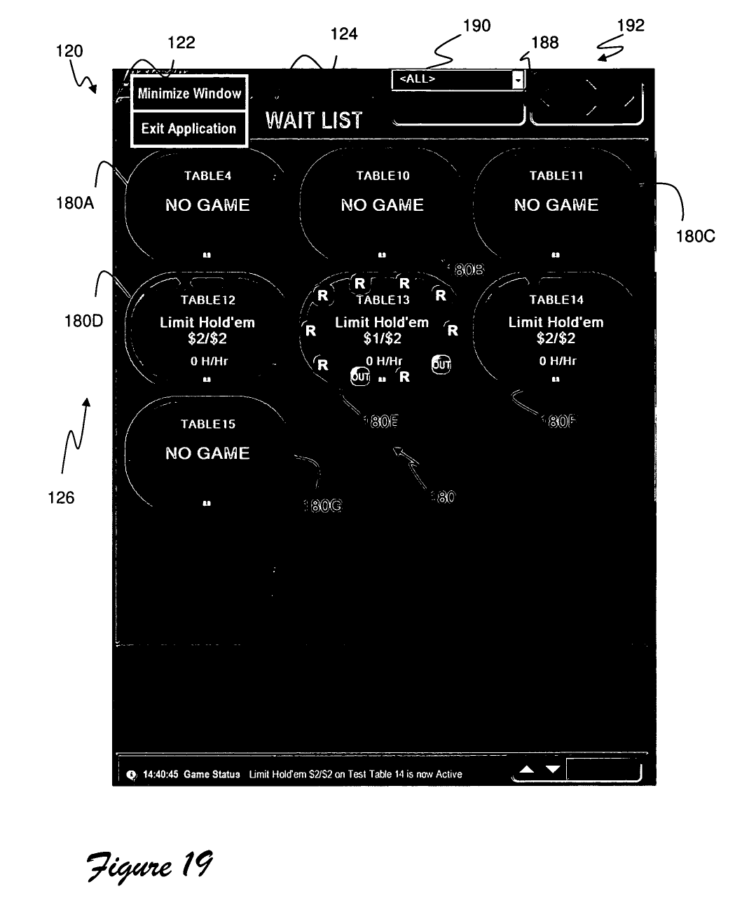

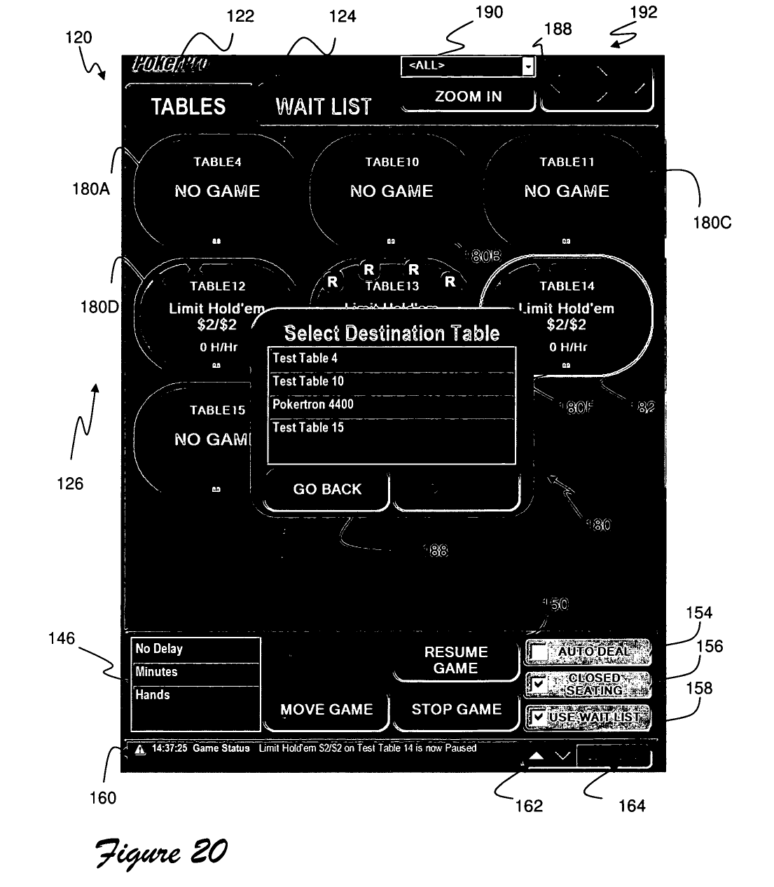

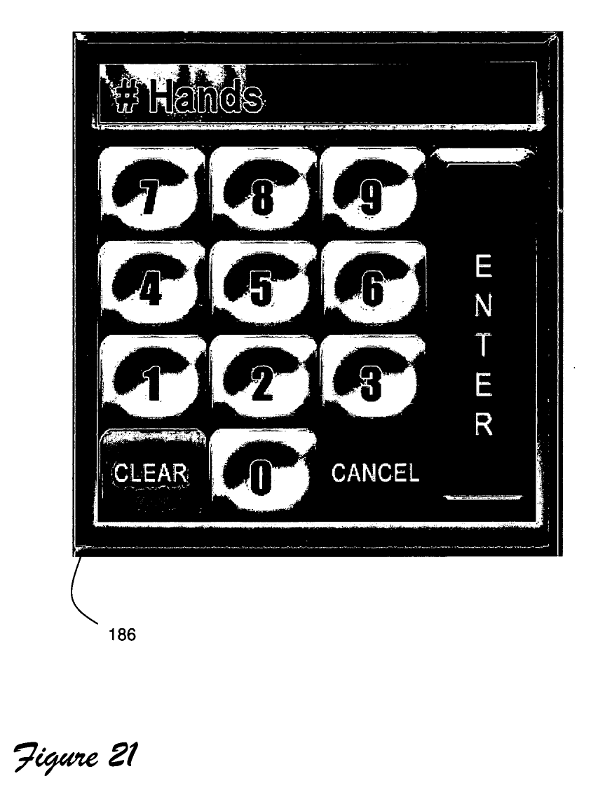

With particular reference to FIG. 18, the table page 126 may also be used to display information regarding the game being played at the selected table 18A-18J. As discussed above, generally, the tables 18A-18J are used to provide an electronic card game, such as poker. The host console 102 may be used to from a list of predefined or selected card games. When providing game information, the table page 126 may include a general section 168, a game play section 170, a rake section 172, and a live action setting section 174.

The general section 168 includes the current game and a description of the current game being played on the selected table 18A-18J. Other information may be dependent upon the current game. In the illustrated embodiment, the selected game if “Limit Hold'em $1/$2”. The general section 168 includes: type, variation, stakes, and jackpots.

The game play section 170 describes parameters which affect game play. In the illustrated embodiment, the game play section 170 includes: maximum raises per hand, action time limit, minimum number of players, and maximum number of players.

The rake section 172 includes information regarding the current rake.

The live action section 174 includes information regarding wagering. For example, the defined game is “Limit Hold'em $1/$2” and the live action section 174 includes information related to the blinds, permissible wagers, and the minimum and maximum stakes allowed.

With particular reference to FIG. 19, the table page 126 may display a graphical representation of the tables 180. In the illustrated embodiment, there are seven tables 180A-180G shown. Each graphical representation 180A-180G may include:

1. The name of the table shown;

2. The game being played at the table (e.g., Limit Hold'em $1/$2 or no game);

3. The number of hands being played per hour.

Each graphical representation 180A-180G may also include the status of each EPIA 24, for example inactive (indicated by a red “X”), active, reserved or out. A reserved EPIA 24 or seat, means that it has been assigned to a player and can only be used by that player. The player must log in to the reserved or assigned EPIA 24 to begin playing. Typically, the player has a predetermined amount of time to log-in to the assigned EPIA 24 or the EPLA/seat begins available again.

As discussed above, games may be paused or stopped through the host console 102. The stop/pause parameter selection area 146 is used to select how the game will be stopped or paused. In the illustrated embodiment, there are three options: no delay, by minutes, or by hands. If no delay is selected, then if the pause or stop game button 150, 152, the game is immediately paused or stopped, respectively.

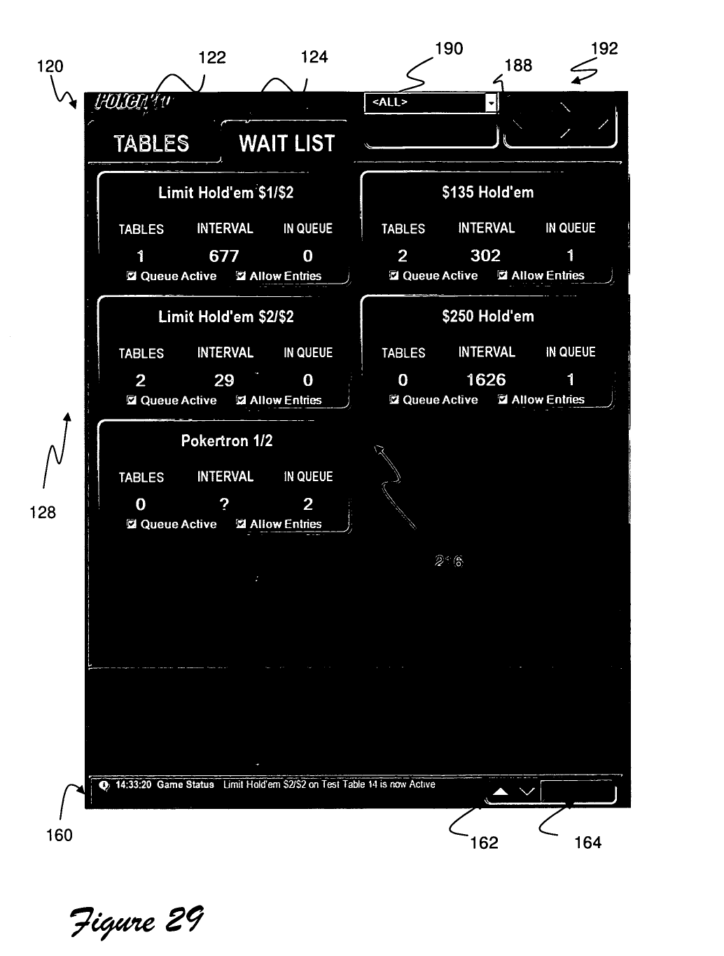

Once a game has been paused, the pause button 150 will be replaced with a resume button 150′ (see FIG. 27).

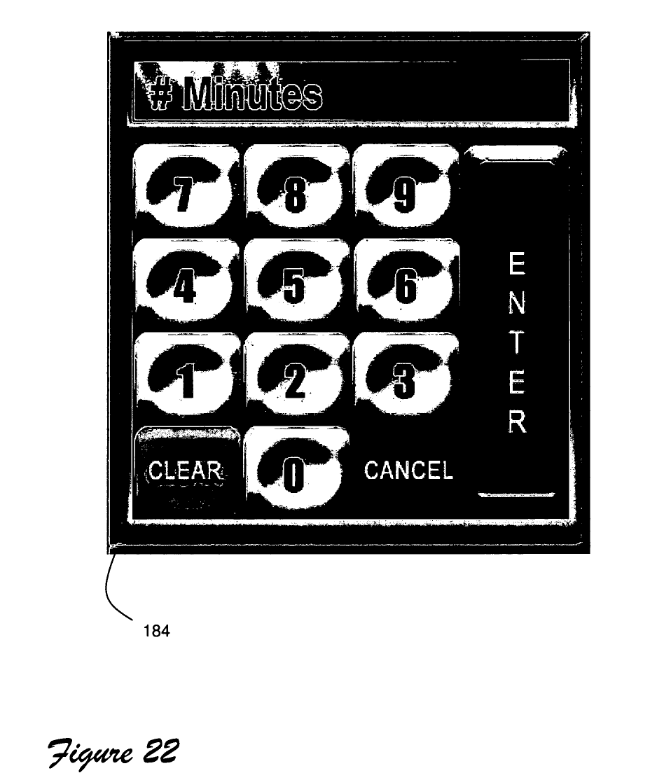

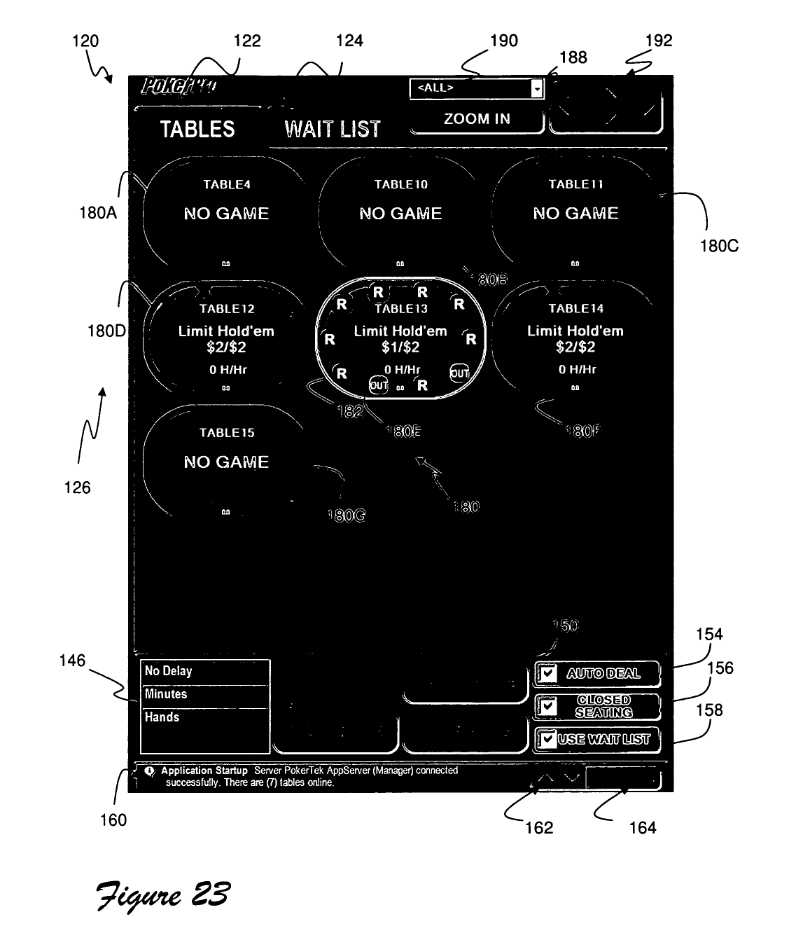

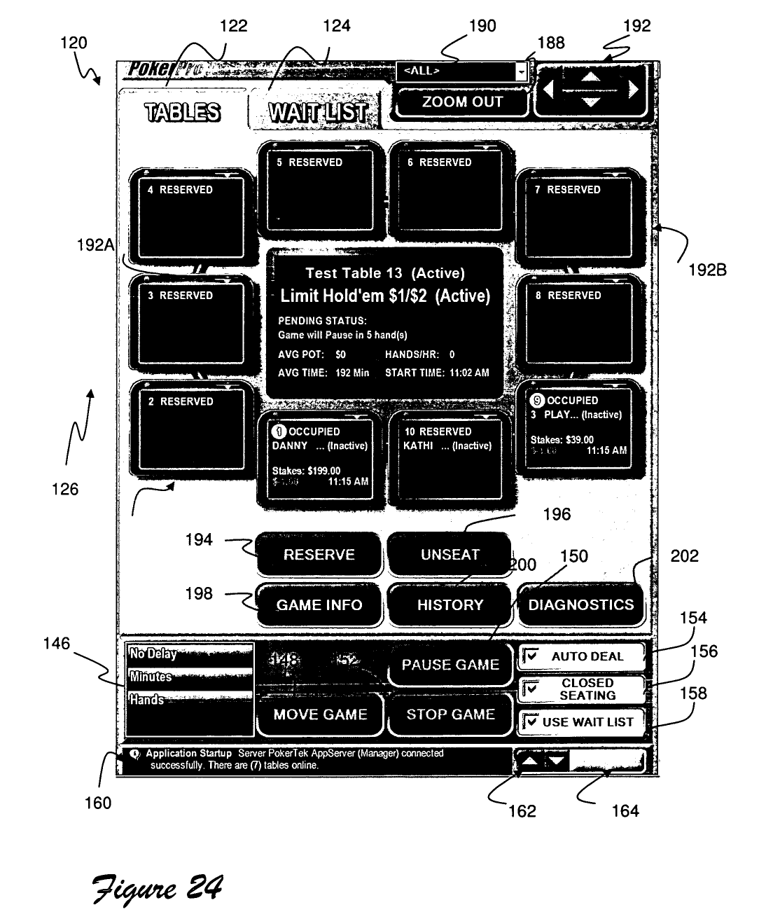

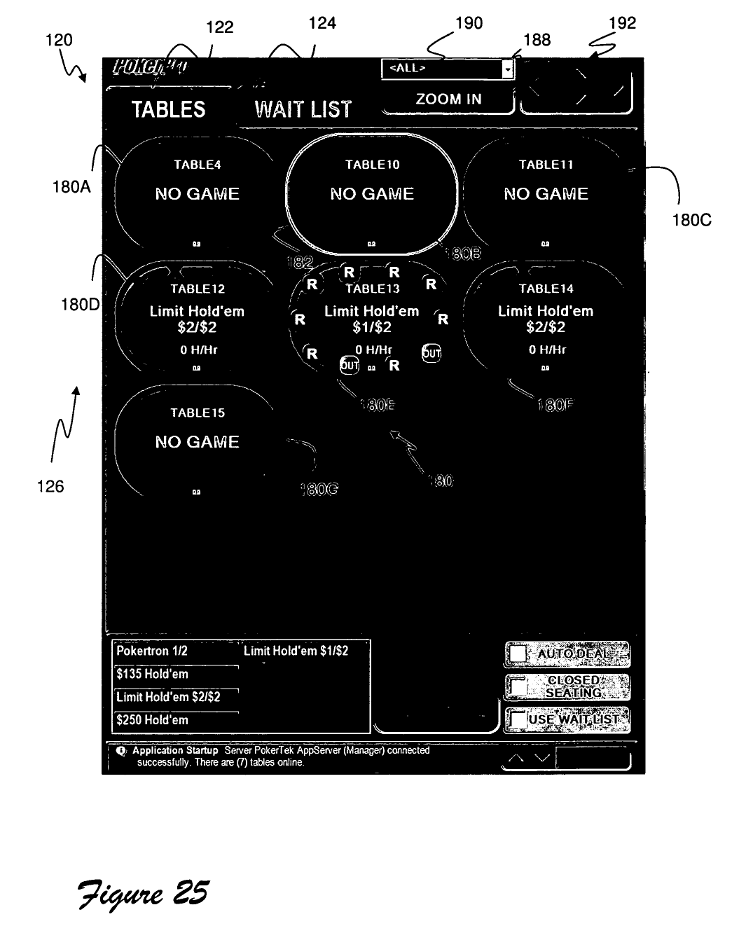

If minutes is selected, then a minute dialog 184 is displayed (see FIG. 22). The minute dialog 184 allows the user to enter when the game will be paused or stopped (in minutes) after the appropriate button is selected.

If hands is selected, then a hands dialog 186 is displayed (see FIG. 21). The hands dialog 186 allows the user to enter when the game will be paused or stopped (in number of hands) after the appropriate button is selected.

With particular reference to FIG. 20, in one aspect of the present invention, the host console 102 may be used to move a game from one table to another table. Moving includes the definition of the game being played on the table being moved, the players and their stacks, and the current state of the game. Generally, the players will be moved to the same seat at the new table.

As shown, the table page 126 shows the graphical representations of the tables 180A-180G. The graphical representation of Table 14 180F has been selected and highlighted with a colored (yellow) band 182. Once the table has been selected, the game must first be paused.

In order to move the game on the Table 14, the table 18 must first be paused (see above). Once the table 18 has been paused and the move game button 148 has been selected, a destination dialog 188 is displayed. The destination dialog 188 allows the user to select the table 18A-18J to which the game at the selected table (Table 14) will be moved.

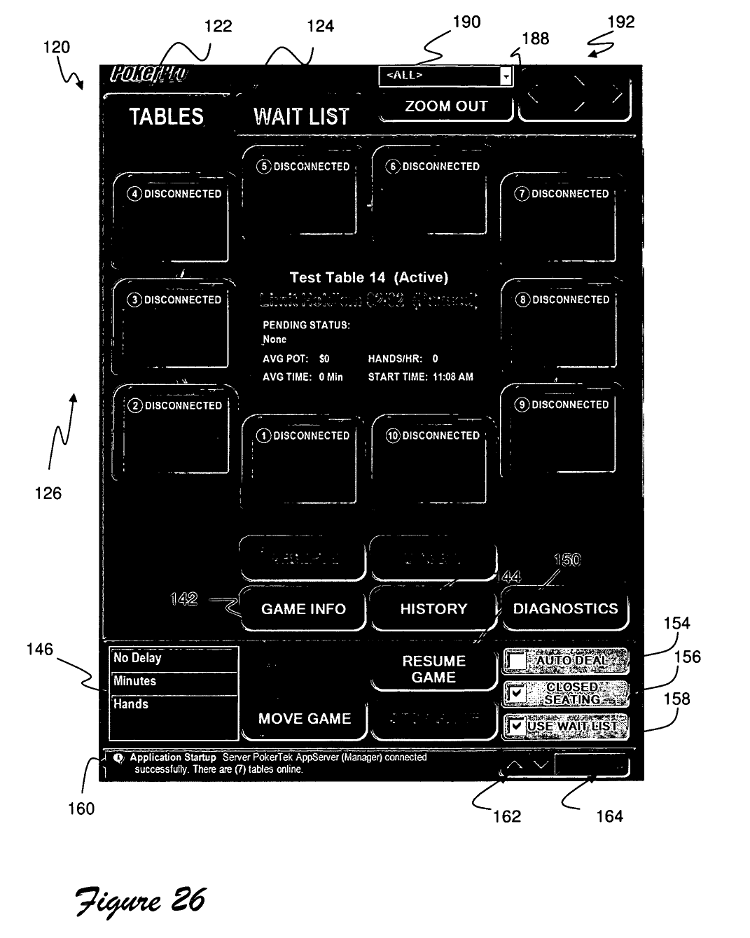

With reference to FIGS. 23-26, each table 18A-18J may be zoomed in onto display additional information. The screen 120 includes a zoom button 188 and a second set of navigation buttons 190. With particular reference to FIG. 23, with the graphical representations of the tables 180 being displayed, a selected table is highlighted with the colored banded 182. The navigation buttons 190 may be used to cycle or move through the graphical representations of the tables 180.

To zoom in on a table, the user may double-click on the graphical representation of the table or select the zoom button 188 to zoom in on the selected table.

With particular reference to FIG. 24, once a table is zoomed in on, the table page 126 displays a graphical representation of the table 192. The graphical representation of the table 192 includes a central information area 192A and a plurality of player information areas 192B. The central information area 192 generally includes information about the table, which may include: name, status, game, pending status, average pot, hands per hour, average wait time to get a seat on the table, and a start time of the current game. The player information areas 192 generally include the seat number, the status (reserved, occupied, etc. . . . ), player name (where appropriate), the player's stake, the player's wins/losses for the current game, and the time player entered the current game.

As shown, the table page 126 may include a reserve (or reserve for player) button 194, an unseat button 196, a game info button 198, a history button 200 and a diagnostics button 202. Selection of the game info button 198, the history button 200, and the diagnostics button 202, will result in game information, history information, and diagnostics information being displayed (see above).

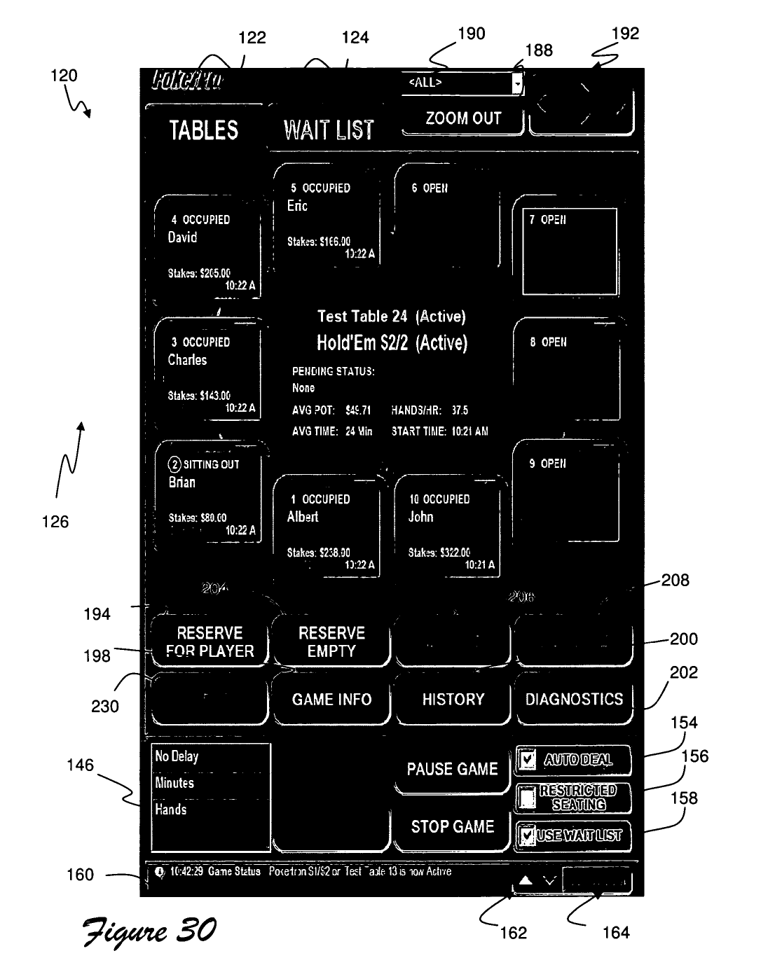

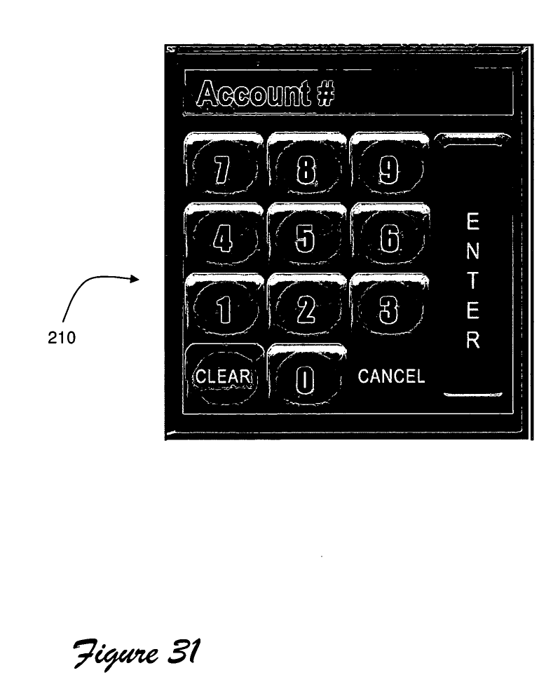

As shown in FIGS. 30-33, the table page 126 may also include a reserve empty button 204, an unseat button 206, and a penalize button 208. The reserve empty button 204 may be used to reserve a seat without designative a specific person. The unseat button 206 may be used to remove a player. The penalize button 208 may be used to adjust a player's stack or otherwise penalize a player. An adjust pot button 230 may be used to adjust the pot of the current hand.

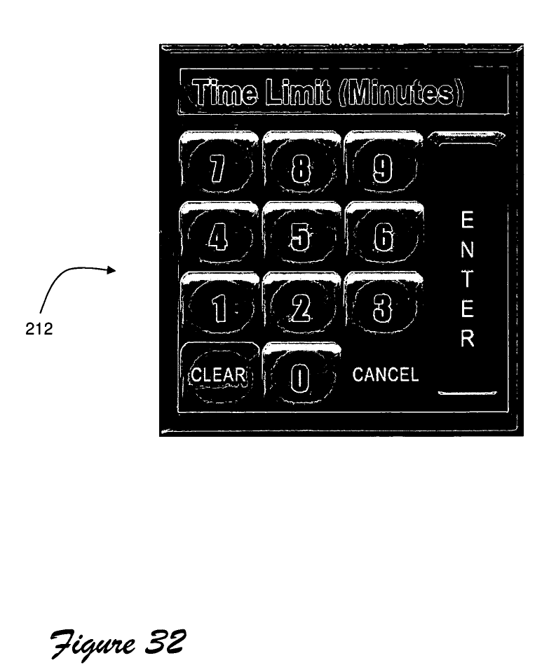

The reserve button 194 allows the user of the host console 102 to reserve a seat for a specific player. In order to do use this button the use wait list check box has to be off and the restricted seating check box has to checked. This allows the user to place the specific player ahead of those players on the wait list, while not opening the seat to anyone who may attempt to log-in or use the unoccupied seat. When the reserve button 194 is selected, an account number dialog 210 is displayed (see FIG. 31). The account number dialog 210 allows the user to enter the account number of the person for whom they are reserving a seat. After the account number has been entered, a time limit dialog 212 is shown. The time limit dialog 212 allows the user to designate how long the reservation will last, i.e., before the player has to log into the EPIA 24.

Typically, a player who has left the table to take or break or for any reason may return as long as they pay any missed blinds. However, the other players may want another player to sit in. The unseat button 206 allows the user to remove a player from the table after the player has left their seat for an amount of time or a number of hands (without logging out).

Once a seat has been reserved, the reservation and the player's name will be reflected at the corresponding graphical representation (see FIG. 33 which shows that seat 7 has been reserved for “Greg”).

With particular reference to FIG. 28, the screen 120 includes a drop down list 214. The drop down list 214 includes a list of all games which may be played on the tables 18. Selecting “all” on the drop down list will display graphical representations of all of the tables 18. Selecting one of the games in the drop down list 214 will display graphical representations of only those tables which are playing that selected game.

With particular reference to FIG. 29, an exemplary wait list page 128. In the illustrated embodiment the wait list page 128 includes a information section 216 for each type of game which may be played on the tables 18. Each information section 216 includes information related to the game and the wait list for that game. In the illustrated embodiment, the information section includes:
1. the number of tables playing the game;
2. the number of players sat in a given interval; and,
3. the number of players in the queue (i.e., the wait list).

The information section 216 may also include a queue active check box and an allow entry check box, which allow the user to turn the wait list on/off for given game and to allow/disallow additional players to be added to the wait list for a given game, respectively.

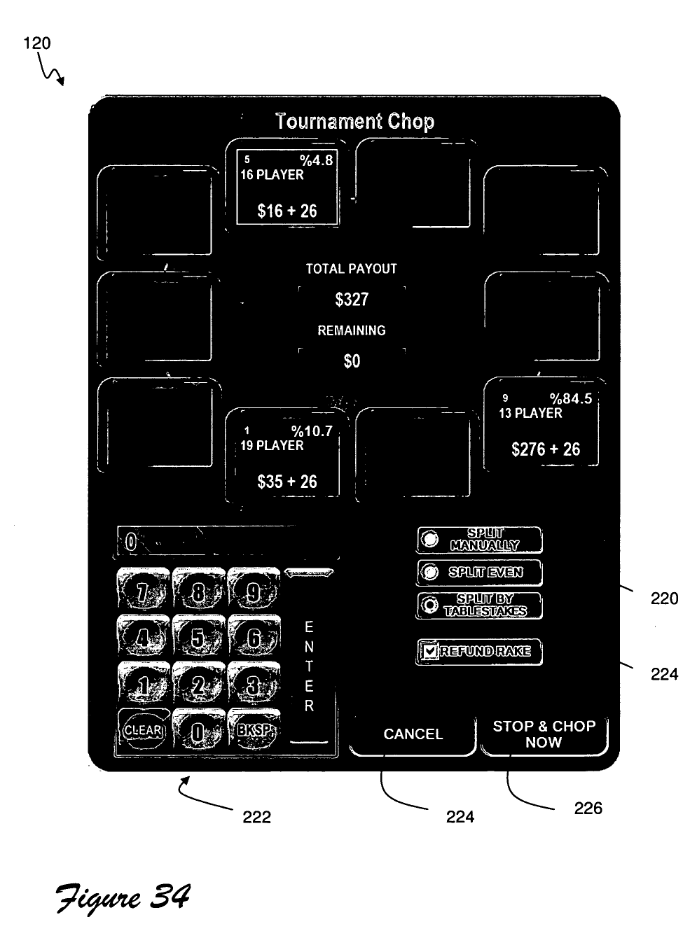

With particular reference to FIG. 34, a tournament chop page 218. The tournament chop page 218 is used only during tournaments and allows the user to stop tournament play prematurely, i.e., before only one player is left, and split the remaining pot or table stakes. The tournament chop page 218 includes a series of check boxes 220 which allow the user to designate how the pot or jackpot will be split. In the illustrated embodiment, there are three options: split manually, split even, or split by table stakes. If split manually is chosen, the corresponding amounts are entered in a key pad 222.

The tournament chop page 218 may also include a refund rake check box 224. A cancel button 224 allows the user to cancel the current operation and return to a previous screen. A stop & chop now button 226 stops the current tournament and splits the pot as designated.

In still another aspect of the present invention, the game computer or server 50, in the event of a fault on one of the player's electronic player interaction area 24, is able to transfer the one player's hand from the respective electronic player interaction area 24 to the host console 102 and allows the one player to finish playing the hand on the host console 102.

Obviously, many modifications and variations of the present invention are possible in light of the above teachings. The invention may be practiced otherwise than as specifically described.

1. A system for providing an electronic card game to a plurality of players, comprising:
at least one electronic card table having a table top with a playing surface and a plurality of electronic player interaction areas located around a periphery of the table top and a central display area located in a central location of the table top, each electronic player interaction area providing a player interface for interaction with one of the players;
a game computer coupled to the plurality of electronic player interaction areas and the central display area for administering the electronic card game using virtual cards and chips; and,
a host console coupled to the game computer for configuring the electronic player interaction areas and the central display area and for establishing parameters of the electronic card game.

2. A system, as set forth in claim 1, wherein the host console provides the ability to turn the at least one electronic card tables on and off.

3. A system, as set forth in claim 1, wherein a plurality of card games may be played at the least one electronic card table, the host console for selecting one of the plurality of card games to be played at the at least one electronic card table.

4. A system, as set forth in claim 1, wherein the parameters are time related.

5. A system, as set forth in claim 1, wherein the parameters include wager limits.

6. A system, as set forth in claim 1, wherein the parameters include amounts associated with a big blind and a little blind for the electronic card game.

7. A system, as set forth in claim 1, the host console for selecting whether the electronic card game is a timed game or a non-timed game.

8. A system, as set forth in claim 10, the host console for establishing parameters of the timed game.

9. A system, as set forth in claim 1, the game computer for requiring players to log on to an electronic player interaction area, the host console for monitoring the players who log on, and producing a signal if a designated player logs on.

10. A system, as set forth in claim 1, the host console for establishing a value associated with the rate of play of hands at the at least one electronic card table.

11. A system, as set forth in claim 1, the host console for pausing playing at the at least one electronic card table.

12. A system, as set forth in claim 1, the host console for locking out and removing one of the players from the table.

13. A system, as set forth in claim 1, wherein each player has an associated stack of virtual chips, the host console for allowing an operator to adjust the stack of virtual chips for one of the players.

14. A system, as set forth in claim 1, the host console for restarting the at least one electronic card table after a fault.

15. A system, as set forth in claim 1, wherein the host console is embodied in a personal computer, a notebook or laptop computer, a table PC, a personal digital assistant, or other suitable device.

16. A system, as set forth in claim 1, the host console for establishing or modifying one or more game profiles, each game profile including parameters for a card game which may be played on the card table.

17. A system, as set forth in claim 1, the parameters including game type and/or limits and/or play timing and/or minimum number of players.

18. A system, as set forth in claim 1, the host console allowing an operator to start and/or pause and/or stop and/or hibernate play of the electronic card game at the electronic card table.

19. A system, as set forth in claim 1, the host console allowing an operator to monitor play of the electronic card game at the electronic card table.

20. A system, as set forth in claim 1, the host console allowing an operator to open and close the electronic card table.

21. A system, as set forth in claim 1, the host console allowing an operator to start ring or tournament games.

22. A system, as set forth in claim 1, the host console allowing an operator to start and/or restart and/or turn off and/or reboot the electronic player interaction areas and/or a table client.

23. A system, as set forth in claim 1, the host console for allowing an operator to select a wagering structure to be used for the electronic card game.

24. A system, as set forth in claim 31, the selected wagering structure being one of limit, no-limit, and pot-limit.

25. A system, as set forth in claim 1, the host console allowing a player to order a beverage and for monitoring the number of beverages ordered by the player.

26. A system, as set forth in claim 1, the host console for allowing a player to request a server.

27. A system, as set forth in claim 1, the host console for allowing an operator to record information related to one of the players.

28. A system, as set forth in claim 1, the host console for allowing an operator to replay a hand.

29. A system, as set forth in claim 28, the host console for displaying the hand being replayed on the host console and/or the central display and/or one or more of the electronic player interaction areas.

30. A system, as set forth in claim 28, the host console for displaying the hand being replayed graphically and/or textually and/or numerically.

31. A system, as set forth in claim 28, the host console for allowing the operator to step through each action or event in the hand being replayed.

32. A system, as set in claim 1, the host console for monitoring play of the electronic card game and establishing a rate of play of hands of the electronic card game.

33. A system, as set forth in claim 32, the host console for comparing the rate of play with a predetermined threshold and signaling an operator of the host console if the rate of play is less than the predetermined threshold.

34. A system, as set forth in claim 1, the host console for receiving an alert initiated by one of the players and signaling an operator of the host console in response to receiving the alert.

35. A system, as set forth in claim 34, wherein the alert is anonymous.

36. A system, as set forth in claim 1, the host console for displaying diagnostic and option information for the electronic card table and/or the electronic player interaction areas and/or the game computer.

37. A system, as set forth in claim 1, the host console for allowing an operator to display information regarding the game and/or history of the game being played on the electronic card table.

38. A system, as set forth in claim 1, the host console for displaying a graphical representation of the electronic card table.

39. A system, as set forth in claim 38, the graphical representation of the electronic card table including a name of the table and/or the game being played at the electronic card table and/or a rate of hands being played at the electronic card table.

40. A system, as set forth in claim 38, the graphical representation of the electronic card table including an indication of the status of each electronic player interaction area.

41. A system, as set forth in claim 1, the host console for allowing an operator to move the game being played at the electronic card table to another electronic card table.

42. A system, as set forth in claim 41, the host console pausing the game at the electronic card table prior to moving the game and allowing the operator to select the another electronic card table from among an available list of electronic card tables.

43. A method for providing an electronic card game to a plurality of players on an electronic card table using a host console and a server computer, the electronic card table having a table top with a playing surface, a plurality of electronic player interaction areas located around a periphery of the table top, and a central display area located in a central location of the table top, each electronic player interaction area providing a player interface for interaction with one of the players, the method comprising:
configuring the electronic player interaction areas and the central display area and establishing parameters of the electronic card game using the host console; and,
administering the electronic card game, by the game computer, using virtual cards and chips.

44. A method, as set forth in claim 43, including the step of allowing an operator to turn the electronic card table on and off using the host console.

45. A method, as set forth in claim 43, wherein a plurality of card games may be played on the electronic card table, the method including the step of allowing an operator to select one of the plurality of card games to be played on the one electronic card table.

46. A method, as set forth in claim 43, wherein the parameters are time related.

47. A method, as set forth in claim 43, wherein the parameters include wager limits.

48. A method, as set forth in claim 43, wherein the parameters include amounts associated with a big blind and a little blind for the electronic card game.

49. A method, as set forth in claim 43, the host console for selecting whether the electronic card game is a timed game or a non-timed game.

50. A method, as set forth in claim 49, wherein the parameters include parameters of the timed game.

51. A method, as set forth in claim 43, including the steps of allowing a player to order drinks through the electronic player interaction area and monitoring the number of drinks provided to the player.

52. A method, as set forth in claim 43, including the steps of requiring players to log on to an electronic player interaction area, monitoring the players who log on, and producing a signal if a designated player logs on.

53. A method, as set forth in claim 43, including the step of establishing a value associated with the rate of play of hands at the at least one electronic card table.

54. A method, as set forth in claim 43, including the step of allowing an operator to pause play at the electronic card table through the host console.

55. A method, as set forth in claim 43, wherein each player has an associated stack of virtual chips, the method including the step of allowing an operator to adjust the stack of virtual chips for one of the players using the host console.

56. A method, as set forth in claim 43, including the step of restarting the at least one electronic card table after a fault using the host console.

57. A method, as set forth in claim 43, wherein the host console is embodied in a personal computer, a notebook or laptop computer, a table PC, a personal digital assistant or other suitable device.

58. A method, as set forth in claim 43, including the step of allowing an operator to establishing or modify one or more game profiles using the host console, each game profile including parameters for a card game which may be played on the card table.

59. A method, as set forth in claim 43, the parameters including game type and/or limits and/or play timing and/or minimum number of players.

60. A method, as set forth in claim 43, including the step of allowing an operator to start and/or pause and/or stop and/or hibernate play of the electronic card game at the electronic card table using the host console.

61. A method, as set forth in claim 43, including the step of allowing an operator to monitor play of the electronic card game at the electronic card table using the host console.

62. A method, as set forth in claim 43, including the step of allowing an operator to open and close the electronic card table using the host console.

63. A method, as set forth in claim 43, including the step of allowing an operator to start ring or tournament games using the host console.

64. A method, as set forth in claim 43, including the step of allowing an operator to start and/or restart and/or turn off and/or reboot the electronic player interaction areas and/or a table client which controls the the game computer using the host console.

65. A method, as set forth in claim 43, including the step of allowing an operator to select a wagering structure to be used for the electronic card game using the host console.

66. A method, as set forth in claim 67, the selected wagering structure being one of limit, no-limit, and pot-limit.

67. A method, as set forth in claim 43, including the step of allowing a player to request a server.

68. A method, as set forth in claim 43, including the step of allowing an operator to record information related to one of the players using the host console.

69. A method, as set forth in claim 43, including the step of allowing an operator to replay a hand using the host console.

70. A method, as set forth in claim 69, including the step of displaying the hand being replayed on the host console and/or the central display and/or one or more of the electronic player interaction areas.

71. A method, as set forth in claim 70, wherein the step of displaying the hand includes displaying the hand being replayed graphically and/or textually and/or numerically.

72. A method, as set forth in claim 70, including the step of allowing the operator to step through each action or event in the hand being replayed.

73. A method, as set in claim 43, including the steps of allowing an operator to monitor play of the electronic card game and establishing a rate of play of hands of the electronic card game by the host console.

74. A method, as set forth in claim 73, including the step of comparing the rate of play with a predetermined threshold and signaling an operator of the host console if the rate of play is less than the predetermined threshold.

75. A method, as set forth in claim 43, including the steps of receiving an alert initiated by one of the players and signaling an operator of the host console in response to receiving the alert.

76. A method, as set forth in claim 75, wherein the alert is anonymous.

77. A method, as set forth in claim 43, including the step of displaying diagnostic and option information for the electronic card table and/or the electronic player interaction areas and/or the game computer on the host console.

78. A method, as set forth in claim 43, including the steps of allowing an operator to display information regarding the game and/or history of the game being played on the electronic card table on the host console.

79. A method, as set forth in claim 43, including the step of displaying a graphical representation of the electronic card table on the host console.

80. A method, as set forth in claim 79, the graphical representation of the electronic card table including a name of the table and/or the game being played at the electronic card table and/or a rate of hands being played at the electronic card table.

81. A method, as set forth in claim 79, the graphical representation of the electronic card table including an indication of the status of each electronic player interaction area.

82. A method, as set forth in claim 43, including the step of allowing an operator to move the game being played at the electronic card table to another electronic card table using the host console.

83. A method, as set forth in claim 82, the step of moving the game including the steps of pausing the game at the electronic card table prior to moving the game and allowing the operator to select the another electronic card table from among an available list of electronic card tables.

84. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing-a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for allowing the operator to turn the at least one electronic card table on and off.

85. A device for use with a system for providing an electronic card game to a plurality of players, the system including at least one electronic card table and a game computer, the electronic card table being able to play a plurality of card games and having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console for allowing the operator to select one of the plurality of card games to be played at the at least one electronic card table.

86. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console for establishing parameters of the electronic card game, wherein the parameters are time related and/or include wager limits and/or indicate the card game as a timed game or a non-timed game.

87. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer for monitoring players who log onto the electronic player interact areas; and,
a user interface implemented on the host console for use by an operator of the host console, the user interface for signaling the operator of the host console if a designated player logs on.

88. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer for establishing a rate of play of hands at the at least one electronic card table; and,
a user interface implemented on the host console for use by an operator of the host console the user interface for displaying the rate of play of hands.

89. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for allowing the operator to adjust a stack of virtual chips associated with one of the players.

90. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for establishing or modifying one or more game profiles, each game profile including parameters for a card game which may be played on the electronic card table.

91. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for establishing parameters of the electronic card game, the parameters including game type and/or play timing and/or minimum number of players.

92. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for allowing the operator to start and/or stop and/or hibernate play of the electronic card game at the electronic card table.

93. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for allowing the operator to monitor play of the electronic card game at the electronic card table.

94. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for allowing the operator to open and close the electronic card table and/or start ring or tournament games and/or start or restart or turn off or reboot the electronic player interaction areas.

95. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for allowing the operator to select a wagering structure for the electronic card game.

96. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for allowing the operator to record information regarding a player.

97. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for allowing the operator to replay a hand of the electronic card game.

98. A device, as set forth in claim 97, the host console for displaying the hand being replayed on the host console and/or the central display and/or one or more of the electronic player interaction areas.

99. A device, as set forth in claim 97, the host console for displaying the hand being replayed graphically and/or textually and/or numerically.

100. A device, as set forth in claim 97, the host console for allowing the operator to step through each action or event in the hand being replayed.

101. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer for receiving an alert initiated by one of the players; and,
a user interface implemented on the host console for use by an operator of the host console, the user interface for signaling the operator in response to having received the alert.

102. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for displaying diagnostic and/or option information for the electronic card table and/or the electronic player interaction areas and/or the game computer.

103. A device for use with a system for providing an electronic card game to a plurality of players, the system including at least one electronic card table and a game computer, the electronic card table having a table top with a playing surface and a plurality of electronic player interaction areas located around a periphery of the table top, each electronic player interaction area providing a player interface for interaction with one of the players, the game computer having a game computer coupled to the plurality of electronic player interaction areas for administering the electronic card game using virtual cards and chips, comprising:
a host console coupled to the game computer; and,
a user interface implemented on the host console for use by an operator of the host console, the user interface for displaying a graphical representation of the electronic card table.

104. A device, as set forth in claim 103, the graphical representation of the electronic card table including a name of the table and/or the game being played at the electronic card table and/or a rate of hands being played at the electronic card table.

105. A system, as set forth in claim 103, the graphical representation of the electronic card table including an indication of the status of each electronic player interaction area.

106. A system for providing an electronic card game to a plurality of players, comprising:
at least one electronic card table having a table top with a playing surface and a plurality of electronic player interaction areas located around a periphery of the table top, each electronic player interaction area providing a player interface for interaction with one of the players;
a game computer coupled to the plurality of electronic player interaction areas for administering the electronic card game using virtual cards and chips; and,
a host console coupled to the game computer, the game computer, in the event of a fault on one of the player's the electronic player interaction area, for transferring the one player's hand from the respective electronic player interaction area to the host console and allowing the one player to finish playing the hand on the host console.
